(19) United States
(12) Patent Application Publication
(10) Pub. No.: US 2025/0193013 A1
(43) Pub. Date: Jun. 12, 2025

(54) METHODS, SYSTEMS, AND COMPUTER READABLE-MEDIA FOR PRIVACY PRESERVING IDENTITY VERIFICATION

(71) Applicant: ANKR PBC, San Francisco, CA (US)

(72) Inventors: Liangnan Wu, Redwood City, CA (US); Kevin Joseph Silk, Boston, MA (US); Suleyman Kardas, Batman (TR); Mehmet Sabir Kiraz, Wigston/Leicester (GB)

(21) Appl. No.: 18/978,523

(22) Filed: Dec. 12, 2024

Related U.S. Application Data
(60) Provisional application No. 63/609,184, filed on Dec. 12, 2023.

(51) Int. Cl. H04L 9/32; H04L 9/00; H04L 9/08

(52) U.S. Cl. CPC H04L 9/3218; H04L 9/0861; H04L 9/50

(57) ABSTRACT

A computer implemented method for verifying a policy proof includes receiving request from a user for a policy, issuing a random challenge nonce, receiving a triple comprising a first genesis state of the user, a zero-knowledge proof of the policy based at least in part on the first random challenge nonce, an account address corresponding to the user, and user data, and a signature of the zero-knowledge proof of the policy, verifying the zero-knowledge proof of the policy based at least in part on the account address of the user, the first random challenge nonce, and one or more states of the user, storing the zero-knowledge proof and the policy identifier in a decentralized storage, publishing the account address corresponding to the user, the policy identifier, and a content identifier to one or more blockchain ledgers.

### CROSS-REFERENCE FOR RELATED APPLICATIONS

This application claims the benefit under 35 U.S.C. § 119 (e) of the earlier filing date of U.S. Provisional Patent Application No. 63/609,184 filed on Dec. 12, 2023, the disclosures of which are incorporated by reference herein.

### FIELD

The present disclosure relates to privacy-preserving user-centric identity protocols.

### BACKGROUND

In computing, networked systems can be divided into two primary categories: centralized and decentralized. A centralized system generally has a single, central entity that controls and manages the flow of information and resources in the system. All communication between devices on the network, like computers or users, goes through the central entity, which acts as a mediator receiving requests, sending back responses, and granting access to data and resources. The central entity is also often responsible for storing all the data in the system and for all the decision making, which makes it easy to keep track of everything that's going on in the system. But there are drawbacks to using centralized networks. For one, if the central entity fails, the whole network may fail, and if someone manages to hack into the central entity, they may be able to access all the data passing through it. Further, there is limited transparency in storing all data in one central location, making it more difficult for users of the network to verify or audit the system.

In contrast, a decentralized system may include multiple entities with equal status in the network, enabling peer to peer communications and decision making by a consensus of more than one entity in the network. A decentralized system may distribute data across multiple entities instead of storing it in one central location, improving data resiliency, as data can be accessed from other entities should one entity fail. Decentralized systems provide a high level of data transparency because information is distributed across multiple entities and not controlled by a single central entity. However, because decentralized systems are distributed, there are challenges protecting data cannot from scrutiny, which can reveal sensitive information about its users.

One challenge in computing is identity verification of users in a digital environment. For example, a specific application or content may require a user to prove that they are who they claim to be or to prove that the user meets a certain policy (e.g., is above the age of 18). To maintain user privacy, it may be desirable for a system to allow user identify verification without disclosing sensitive personal information, for example to verify that a user is over the age of 18 without disclosing the user's actual age or other sensitive personal information like the user's name, address, citizenship, or similar information. Known solutions for identity validation require centralized exchanges, which create privacy and tracking concerns. Accordingly, a need exists for privacy preserving identity verification systems.

### SUMMARY

In some aspects, the present disclosure relates to a computer implemented method for verifying a policy proof, the method comprising: receiving, by at least one processor of one or more processors that are communicably coupled to a computing environment, a request from a user for a policy, wherein the request comprises a policy identifier corresponding to the policy, and wherein the policy comprises one or more queries, each query is based at least in part on a claim, and each claim comprises a claim index and a claim value; issuing, by at least one processor of one or more processors that are communicably coupled to the computing environment, a first random challenge nonce; receiving, by at least one processor of one or more processors that are communicably coupled to the computing environment, a first triple comprising: a first genesis state of the user; a zero-knowledge proof of the policy based at least in part on the first random challenge nonce, an account address corresponding to the user, and user data; and a signature of the zero-knowledge proof of the policy; verifying, by at least one processor of one or more processors that are communicably coupled to the computing environment, the zero-knowledge proof of the policy based at least in part on the account address of the user, the first random challenge nonce, and one or more states of the user; storing, by at least one processor of one or more processors that are communicably coupled to the computing environment, the zero-knowledge proof and the policy identifier in a decentralized storage; and publishing, by at least one processor of one or more processors that are communicably coupled to the computing environment, the account address corresponding to the user, the policy identifier, and a content identifier to one or more blockchain ledgers, wherein the content identifier corresponds to the claims of the one or more queries of the policy.

The method can further include the steps of generating, by at least one processor of one or more processors that are communicably coupled to a computing environment, a transaction hash ID corresponding to a verification of the policy; and transmitting, by at least one processor of one or more processors that are communicably coupled to the computing environment, the transaction has ID to the user.

The method can further include the step of revoking, by at least one processor of one or more processors that are communicably coupled to the computing environment, at least one of the one or more claims of the policy.

The step of revoking at least one of the one or more claims of the policy can include receiving, by at least one processor of one or more processors that are communicably coupled to the computing environment, a request to revoke at least one of the one or more claims of the policy, the request comprising the account address of the user and a claim index corresponding to at least one of the one or more claims of the policy to be revoked; transmitting, by at least one processor of one or more processors that are communicably coupled to the computing environment, a second triple to an issuer, the second triple comprising: a second genesis state of the user; a signature of a second random challenge nonce and a hash of the claim value corresponding to the claim index of the claim, wherein the at least one of the one or more claims of the policy to be revoked; and a revocation nonce of the at least one of the one or more claims of the policy to be revoked; receiving, by at least one processor of one or more processors that are communicably coupled to the computing environment, a transaction hash ID corresponding to the revocation of the at least one of the one or more claims of the policy to be revoked; updating, by at least one processor of one or more processors that are communicably coupled to the computing environment, a revocation tree based at least in part on the revocation of the at least one of the one or more claims of the policy to be revoked; generating, by at least one processor of one or more processors that are communicably coupled to the computing environment, a state transition proof of the user based at least in part on the revocation of the at least one of the one or more claims of the policy to be revoked; and publishing, by at least one processor of one or more processors that are communicably coupled to the computing environment, the state transition proof to one or more blockchain ledgers.

In some aspects, the zero-knowledge proof of the policy is a SNARK proof.

The method can further include the steps of registering, by at least one processor of one or more processors that are communicably coupled to the computing environment, the user with an issuer.

The step of registering the user with an issuer can further include requesting, by at least one processor of one or more processors that are communicably coupled to the computing environment, registration with an issuer; signing, by at least one processor of one or more processors that are communicably coupled to the computing environment, a third random challenge nonce with a private key of the user; receiving, by at least one processor of one or more processors that are communicably coupled to the computing environment, an access token based at least in part on a verification of the signed third random challenge nonce; transmitting, by at least one processor of one or more processors that are communicably coupled to the computing environment, a third triple comprising: a blockchain address corresponding to a user encryption key pair; a user encryption key; and a user public authentication key; and receiving, by at least one processor of one or more processors that are communicably coupled to the computing environment, a success flag, the success flag based at least in part on a third genesis state of the user, the third genesis state of the user being determined based at least in part on the user public authentication key and the blockchain address corresponding to the user encryption key pair.

In some aspects, the user public encryption key is derived from a Baby Jubjub curve.

The method can further include the step of updating, by at least one processor of one or more processors that are communicably coupled to the computing environment, at least one of the one or more claims of the policy.

In some aspects, the present disclosure relates to a system for verifying a policy proof. The system includes one or more processors and one or more memories operatively coupled to at least one of the one or more processors and having instructions stored thereon that, when executed by at least one of the one or more processors, cause at least one of the one or more processors to perform any of the methods described above.

In some aspects, the present disclosure relates to at least one non-transitory computer-readable medium storing computer-readable instructions that, when executed by at least one of one or more computing devices, cause at least one of the one or more computing devices to perform any of the methods described above.

### BRIEF DESCRIPTION OF THE DRAWINGS

FIG. 1 illustrates a computing environment according to an exemplary embodiment.

FIG. 2 illustrates an exemplary embodiment of a data structure for determining an identity state.

FIG. 3 illustrates a flowchart of a method for proving a claim according to an exemplary embodiment.

FIG. 4 illustrates a flowchart of a method for registering a user with an issuer according to an exemplary embodiment.

FIG. 5 illustrates a flowchart of a method for issuing a claim to a user according to an exemplary embodiment.

FIG. 6 illustrates a flowchart of a method for updating a claim according to an exemplary embodiment.

FIG. 7 illustrates a flowchart of a method for generating a transaction hash ID according to an exemplary embodiment.

FIG. 8 illustrates a flowchart of a method for revoking a claim according to an exemplary embodiment.

FIG. 9 illustrates a flowchart of a method for generating a transaction hash ID according to an exemplary embodiment.

FIG. 10 illustrates a flowchart of a method for verifying a policy proof according to an exemplary embodiment.

FIG. 11 illustrates an exemplary embodiment of a state transition circuit.

FIG. 12 illustrates embodiments of a computer system within a network environment in accordance with this disclosure.

### DETAILED DESCRIPTION

This disclosure describes a novel solution to identity verification in a digital environment that preserves user privacy.

The methods, systems, and non-transitory computer-readable medium described herein present a novel approach to identity authentication and verification using a combination of centralized and decentralized computing entities. The methods, systems, and non-transitory computer-readable medium utilize public blockchain ledgers to verify identities using zero-knowledge proofs without revealing the actual identity of the prover of the information related to the prover, thus preserving privacy and preventing tracking of the prover. The methods, systems, and non-transitory computer-readable medium further enable users to be issued digital certificates from one or more centralized issuers and then prove possession of that digital certificate with a decentralized blockchain ledger. The methods, systems, and non-transitory computer-readable medium allow sensitive information of users to remain secret and not written to a public blockchain while at the same time giving the users access to that public blockchain based on that sensitive information, overcoming a drawback of public blockchains related to a lack of privacy/secrecy in the information disclosed on the blockchain. This solution further grants users the benefit of the decentralized nature of a blockchain related to visibility and reliability stemming from the public nature of the blockchain while also granting the benefit of privacy and security provided by private, centralized entities.

A Baby Jubjub refers to an elliptic curve defined over a finite field GF of (2²⁵⁵-19), denoting its unique characteristics and significance in cryptography. The Baby Jubjub curve can be defined by an equation E: y²=x³+3. The form defined by this equation conforms to a twisted Edwards form, a design choice that endows it with desirable cryptographic properties. In particular, this curve offers robust resistance against various attacks targeting discrete logarithmic problems, rendering the Baby Jubjub curve a valuable tool for secure key exchange and digital signatures.

One of the most compelling features of the Baby Jubjub curve is its relatively small characteristic (2²⁵⁵-19), which is well-suited for resource-constrained environments. This characteristic allows for the generation of shorter key lengths, which is particularly advantageous in scenarios where memory and bandwidth constraints are prevalent. The relatively small characteristic of the Baby Jubjub curve also facilitates efficient arithmetic operations, resulting in faster cryptographic computations.

Public Key Encryption (PKE) utilizes asymmetric key pairs consisting of a public key and a private key. The public key functions as the encryption mechanism, while the private key remains confidential to the user, enabling decryption of data encrypted with the key pair. The security of PKE relies on the computational hard problems, like integer factorization or the discrete logarithm problem, making it extremely challenging for adversaries to derive the private key from the public key.

An example of PKE includes an ECIES (Elliptic Curve Integrated Encryption Scheme). ECIES leverages elliptic curve cryptography to facilitate secure data exchange. ECIES employs keys with relatively short lengths for faster encryption and decryption procedures without loss of security. In ECIES, a sender uses a recipient's public key to perform encryption, while the recipient executes a decryption process with the corresponding private key. ECIES can integrate symmetric encryption, like AES (Advanced Encryption Standard) with the cryptographic strength of elliptic curve cryptography, ensuring data confidentiality, integrity, and authenticity. This amalgamation of cryptographic techniques produces a high level of security.

ECIES employs a number of cryptographic functions, including but not limited to:

A Key Agreement (KA), which can generate a shared secret between two parties (e.g., a sender and a recipient);

A Key Derivation Function (KDF), which can produce a set of keys from keying material and optional parameters;

An Encryption SymEnc and SymDec, which can be a symmetric encryption and decryption process, respectively;

A Message Authentication Code (MAC), which can be used to authenticate messages; and

A Hash, which can be a cryptographic hash utilized within the KDF and MAC.

By way of example, encrypting a plaintext message can include a sender, Alice, transmitting a message to a recipient, Bob. Alice's private and public keys may be denoted as u and U, respectively. Similarly, Bob's private and public keys may be denoted as v and V, respectively. The private keys u and v may be elements of a finite Elliptic Curve Cryptography (ECC) field, while the public keys U and V may be points on the elliptic curve derived as the product of the respective private key and the curve's generator, G. As a first step, Alice can initiate the creation of an ephemeral private-public key pair (u, U) where u is a finite field element and U, which is derived as uG is a point on the elliptic curve having a generator G. After the ephemeral keys u and U have been created, Alice can employ a KA to construct a shared secret key. This shared secret key may be determined as a scalar multiplication of uV, utilizing Alice's private key u and Bob's public key V as inputs. Subsequently, Alice can take the shared secret key uV, alongside other optional parameters (e.g., a binary representation of her ephemeral public key U), as input data for a KDF. The output of this KDF includes a concatenation of the symmetric encryption key kEnc and the MAC key kMAC. Utilizing element kENC and a plaintext message m, Alice can then calculate a ciphertext c=SymEnckEnc (m). Using the ciphertext c, kMAC, and other optional parameters (if applicable) agreed upon by both parties to the transaction (i.e., the sender Alice and the recipient Bob), Alice applies a MAC to the cipher text c to produce a tag. Finally, Alice can assemble her public key U, the tag, and the ciphertext c, and transmit a cryptogram (U∥ tag∥c), which is the concatenation of U, the tag, and ciphertext c, to Bob.

Upon receiving the cryptogram (U∥tag∥c) from Alice, Bob extracts Alice's public key U, the tag, and ciphertext c. Bob then produces a secret key as the product of the scalar multiplication of Alice's public key U and Bob's private key v, yielding a shared secret key vU. This calculation can result in the same value as the product uV when there is an underlying Diffie-Hellman protocol present. Utilizing the shared secret value vU and the same optional parameters previously used by Alice (if applicable), Bob can use the KDF to generate the same encryption and MAC keys generated by Alice. With the MAC key kMAC, ciphertext c, and the same optional parameters utilized by Alice, Bob can compute an element tag*and then compare its value with the tag received from Alice as part of the cryptogram to check and confirm the integrity of the message. If Alice's tag and Bob's tag*are not the same, Bob may reject the cryptogram due to a failure in the MAC verification. If Alice's tag and Bob's tag*are the same, Bob can proceed with decryption and obtain the intended plaintext m by decrypting the ciphertext c according to m=SymDeckEnc (c).

Digital signatures are cryptographic tools used in blockchain technology. Many digital signature schemes, such as, but not limited to, ECDSA (Elliptic Curve Digital Signature Algorithm), EdDSA (Edwards-curve Digital Signature Algorithm), and BLS (Boneh-Lynn-Shacham), utilize a pair of keys that include a public key and a private key, where the public key is used for receiving digital assets, and the private key is used to digitally sign transactions. Importantly, these digital signatures can be verified against the public key without exposing the private key. Digital wallets, sometimes referred to as crypto wallets, serve as applications for managing access to digital assets, handling keys and addresses, tracking balances, and creating and signing transactions. These wallets can store and manage private and public keys rather than the assets themselves, like crypto currency, NFTs, and other digital tokens. Users can utilize their private and public keys to sign transactions, providing proof of ownership over assets subject to the transaction.

A digital signature according to the ECDSA can verify the authenticity of a message and the identity of a signer of the message while ensuring the integrity and non-repudiation of the message. This process can include first generating a key, using the key to sign a message, and verifying the signed message. Generating a key for the signature can include selecting an elliptic curve, which can be represented by its domain parameters, including a prime field modulus p, curve coefficients a and b, a base point G, and an order n. A private key d can then be generated as a randomly selected integer in the range [1, n-1]. A corresponding public key [symbol] can be determined by multiplying base point G by the private key d (i.e., [symbol] =d*G). This public key Q can include two coordinates, Qx and Qy, which represent a point on the elliptic curve.

In order to sign a message using these keys, a hash of the message to be signed is first generated. This hash can be determined according to SHA256, or other hash functions. A random nonce k in the range [1, n−1] is then generated, a nonce point K is computed by multiplying base point G by random nonce k (i.e., K=k*G), and an inverse of the random nonce k⁻¹ mod n and be computed. Next, an x-coordinate of the nonce point Kx mod n is calculated. Using the x-coordinate of nonce point K, a first component r of the signature is determined as r=Kx mod n, where r cannot equal 0. Then, a hash h of the message is determined, where hash h is an integer. Using the hash h, a second component s of the signature is determined according to s=k⁻¹*(h+d*r) mod n, where s cannot equal 0. The resulting pair (r, s) serves as the ECDSA signature of the message.

Lastly, the message signature can be verified. This verification process includes first retrieving the public key Q of the signer of the message. The message hash h of the received message is computed, ensuring that r and s are within the range [1, n−1]. Using a multiplicative inverse of s (i.e., s⁻¹) modulo n, value w=s⁻¹ mod n is then determined. Then, the hash of the message h is calculated as an integer. A first verification parameter u1 and a second verification parameter u2 are then determined, where u1=(h*w)(modn), and u2=(r*w) mod n. The first and second verification parameters are then used to calculate an elliptic curve point X as X=u1*G+u2*Q, where*represents point multiplication and addition on the elliptic curve. If X is the point at infinity or if Xx (the x-coordinate of X) is not congruent tor mod n, the signature is invalid. Otherwise, the signature is considered valid.

Another digital signature process is described by the Edwards-curve Digital Signature Algorithm (EdDSA). EdDSA is a secure signature process that is resistant to cryptographic hacks. For key generation, an Edwards curve is elected, represented by the curve's parameters, which can include a prime field modulus p, a curve equation ax²+y²=1+dx²y², and a base point B. A random scalar a, which serves as the private key, is chosen. A corresponding public key is determined by multiplying base point B by private key a, yielding the public key A (i.e., A=a*B). Public key A therefore represents a point on the curve, (i.e., A=(x, y)).

The signature process of the EdDSA further includes generating a random nonce k, which may be secret and unique for each signature. A nonce point K is then determined by multiplying base point B by random nonce k (i.e., (K=k*B)). Next, an x-coordinate of nonce point K modulo the curve's order L is calculated. L may be related to the curve's prime order, which can be but is not limited to L=2252+27742317777372353535851937790883648493. A hash of the message to be signed is then determined in order to obtain a message digest h. Then, an x-coordinate r of nonce point K modulo L is determined (i.e., r=Kx mod L), ensuring that r is not equal to zero. A second hash is generated using r, public key A, and the message digest h. Then, a value s is calculated as the product of nonce k and the second hash, plus private key a (i.e., s=k*h+a). Finally, the modular inverse of s modulo L is determined, and the EdDSA signature can be represented as the pair (r, s).

The process of signature verification of the EdDSA signature can then begin by first ensuring that r and s are within the range [1, L−1]. Then, the hash of the signed message can be calculated to obtain a message digest hs. Then, a first verification parameter u1 and a second verification parameter u2 can be determined, where u1=hs*s−1 mod L, and u2=r*s−1 mod L. A verification point Vis determined as V=u1*B+u2*A, where*represents point multiplication on the curve. If V is the point at infinity, or if its x-coordinate matches r, then the signature is valid; otherwise, it is considered invalid.

Bilinear maps are mathematical constructs defined over two additive cyclic groups, denoted as (G₁, +) and (G₂, +), both having a nearly prime order of q. These groups can be represented as G₁=<P> and G₂=<0>. Additionally, a multiplicative cyclic group G_{T} of order q, represented as G_{T}=<g>, can be used in conjunction with these additive groups. In this context, “0” denotes the identity element in G₁ and G₂, while “1” represents the identity element in G_{T}. A bilinear map, denoted as e, can represent a mathematical function that maps pairs of elements from G₁ and G₂ to G_{T}. Function e can be a group of homomorphism in each component, meaning that all pairs of elements P₁, P₁′ in G₁ and [symbol] ₁, [symbol] ₁′ in G₂, e (P₁+P₁, [symbol] ₁)=e (P₁,Q₁)*e(P₁′,Q₁) and e(P₁,Q₁+Q₁′)=e (P₁,Q₁)*e (P₁,Q₁′). In this way, function e possesses bilinearity properties. Function e can also be non-degenerate in each component, meaning that for any P₁ in G₁ where P₁ is not equal to 0, there exists an element Q₁ in G₂ such that e (P₁, Q₁) is not equal to 1. Similarly, for any Q₁ in G₂ where Q₁ is not equal to 0, there exists an element P₁ in G₁ such that e (P₁, Q₁) is not equal to 1. Lastly, there can be a way to compute the bilinear map e, giving it the property of computability.

Zero-Knowledge Succinct Non-Interactive Arguments of Knowledge (zkSNARK) are a category of zero-knowledge proofs that enable efficient verification of statement validity without revealing any information about the inputs of the statement. A zkSNARK offers succinct proofs that enable rapid verification, often in a matter of milliseconds. In a zkSNARK proof system, a prover aims to convince a verifier that a certain statement is true without disclosing any other details, ensuring that the verifier only learns the truth of the statement without any additional information, including the information contained in the statement. A zkSNARK proof relies on the properties of:
Completeness: If the statement is true, the prover can successfully convince the verifier;
Soundness: A dishonest prover cannot persuade the verifier that a false statement is true;
Zero-knowledge: The interaction between the prover and the verifier reveals only the truth of the statement and nothing more;
Succinctness: The size of the proof is smaller than the size of the statement, and the verifier's computational effort in verifying the statement as true is less than the size of the statement;
Non-interactivity: The proof is conveyed in a single message from the prover to the verifier;
Argument: The system or environment in which the proof is verified is computationally sound, meaning that an unbounded prover cannot prove false statements; and
Knowledge: The prover genuinely possesses knowledge of a witness, and there exists an extractor process that interacts with the prover to extract the witness. A witness, as used herein, refers to a piece of information that enables efficient verification that a statement is in fact true.

Structured Reference String (SRS) can be a component within a zkSNARK proof process. An SRS is a cryptographic method that enables a prover to convince a verifier of the truth of a statement without revealing the underlying data on the statement. The SRS describes a predefined set of values that both the prover and verifier use to create and verify succinct proofs. The SRS can include elements such as cryptographic parameters, keys, and other setup information generated during a one-time trusted setup phase. An SRS can be created by a set of participants in a ceremony, and generation of an SRS must be performed honestly to avoid potential security vulnerabilities. Once the SRS is established, it can be used to create and verify zkSNARK proofs for a wide range of applications, including confidential transactions in cryptocurrencies, identity verification, and more.

An exemplary zkSNARK is Groth16. Groth16 is a zkSNARK construction that relies on bilinear pairings, such as a Weil or a Tate pairing e (e.g., e: G₁×G₂→G_{T}), defined over elliptic curve groups G₁, G₂, and G_{T}. Groth16 relies on the algebraic properties of elliptic curves, including non-degeneracy, bilinearity, and associativity of pairings. Leveraging these properties, Groth16 produces non-interactive, succinct zero-knowledge proofs, with statements represented by mathematical predicates f (e.g., f: G₁→0, 1) and information remaining concealed by witnesses w (e.g., w: G₁).

A key feature of a Groth16 zkSNARK is its succinctness, which says that the size of the proof, represented as π, is significantly smaller than the size of the statement or data being proven. This succinctness results from algebraic constructions and computational optimizations, making Groth16 particularly suitable for resource-constrained contexts, exemplified in many blockchain and distributed ledger applications. In domains necessitating uncompromising privacy preservation, computational thrift, and cryptographic rigor, Groth16 maintains its mathematical preeminence, perpetually influencing the landscape of zero-knowledge proof systems.

Another exemplary zkSNARK includes a Plonk zkSNARK. A Plonk zkSNARK allows a reference string generated during a trusted setup process to be reused for another iteration of the Plonk zkSNARK of equal or smaller size than the original. Moreover, this reference string can be periodically updated, and each update reduces the risk of a compromise through collusion. By employing alternative polynomial commitment schemes, a Plonk zkSNARK can transform into a STARK (Scalable Transparent Argument of Knowledge) without need for any trusted setup.

In some embodiments, a Plonk zkSNARK can use a polynomial commitment scheme, such as Kate commitments. Kate commitments use an elliptic curve on which efficient elliptic curve pairings can be computed. An elliptic curve is considered “pairing-friendly” when its pairing function can be efficiently computed without compromising security. Other pairing-friendly curves, such as BN-254 and BLS12-381, may alternatively be chosen for the Plonk zkSNARK.

In the realm of SNARKs, cryptographic hash functions are denoted by H(.): {0, 1}*→{0, 1} [symbol] . In some embodiments, a length of the output can remain fixed, such as when H is a SHA256 based hash, 1=256.

Unfortunately, the SHA256 compression function is highly inefficient when used with SNARKs due to its size, requiring approximately 27,000 constraints for inputs of 448 bits. In contrast, MiMC/e7r91, designed for 256-bit security (with 448 bits of input), requires only about 730 constraints. Similarly, MiMC/e7r46, targeting 128-bit security (with 448 bits of input), necessitates roughly 370 constraints. Poseidon stands out as a particularly efficient implementation that is friendly to zkSNARKs. Poseidon requires approximately 9 constraints per input bit for its implementation, meaning it needs about 2,304 constraints for 256 bits of input (256×9) and approximately 4,032 constraints for 448 bits of input (448×9), which is significantly lower than SHA256's requirement of roughly 27,000 constraints for a similar input size.

A Merkle tree, also known as a hash tree, refers to a specialized data structure that utilizes cryptographic hashing to efficiently summarize and verify the integrity of large datasets. Merkle trees can be constructed as binary trees comprising a plurality of nodes, where each node of the Merkle tree can have a maximum of two child nodes. A leaf node refers to nodes located at extremities of the Merkle tree, and each leaf node can hold a cryptographic hash of individual data blocks. Non-leaf nodes, which refer to nodes further up the Merkle tree and not at an extremity of the Merkle tree, can contain the cryptographic hashes of their two child nodes.

Data within a Merkle tree can be indexed, and each data block can be assigned to a specific leaf node based on its index. This deterministic placement ensures that the order of data insertion does not affect the final Merkle tree root, which is a unique identifier representing the entire dataset stored in the Merkle tree. Due to the indexed data placement, some nodes in the Merkle tree may remain empty, for example when a dataset is sparse, i.e., not fully populated. Advantageously, sparseness in a dataset does not affect the tree's integrity or its verification capabilities. Instead, sparseness can contribute to the tree's efficient storage and computation capabilities.

Advantageously, a Merkle tree permits verification of membership of a leaf node in the tree. Namely, a membership proof, which may be referred to as a Merkle Proof, can include a collection of hash values used to demonstrate that a particular leaf node belongs to the tree. This proof can be associated with a specific leaf node and can be constructed using the leaf node's sibling nodes and all non-leaf node hashes that cannot be computed without the inclusion of extra leaf nodes.

From a Merkle tree, Proof-of-Private-Membership Trees (PPTs) can be constructed to prove membership of a set without revealing the member's identity or the specific set the member is part of. In other words, the inventors have discovered a novel process to PPTs using a zero-knowledge proof, such as a zkSNARK proof, on a Merkle tree as a cryptographic approach to secure and private data verification within a Merkle tree structure. Mainly, this technique leverages zkSNARK, or other zero-knowledge proofs, to enable a prover to demonstrate knowledge of information without revealing the information itself, ensuring confidentiality and secrecy of the information. This approach can be particularly relevant in the context of blockchain technology and privacy-preserving applications.

As disclosed herein, this disclosure's novel approach to private membership verification can include proving that a specific leaf node exists within a Merkle tree without disclosing any details about the leaf itself or the tree's internal structure. This can be achieved by utilizing a zero-knowledge proof, such as a zkSNARK, to generate succinct and non-interactive proofs. These proofs consist of a succinct argument that the prover has knowledge of a valid path leading from the leaf node to the root of the Merkle tree, without revealing any specific information about the path, the leaf node's identity, or the other leaves in the Merkle tree.

In some embodiments, proving membership includes first obtaining a membership witness for a leaf node for which membership is to be proven. This witness can include a value of the leaf node, an index of the leaf node in the tree, and a sibling path from the leaf node to the root of the tree. Next, a zero-knowledge proof, such as a zkSNARK proof, is generated by the prover to prove the validity of the membership witness. The prover then sends the proof to a verifier who can verify the proof and confirm the root of the Merkle tree matches a stored Merkle tree root. Upon verification, the verifier confirms the prover is a member of a set without knowledge of the identity of the prover or of the particular set the prover is a member of. This novel process ensures data integrity and confidentiality while maximizing computational and communication overhead. This novel process is efficient and scalable, and can be used in a variety of applications, including but not limited to, privacy-preserving authentication, access control, and more.

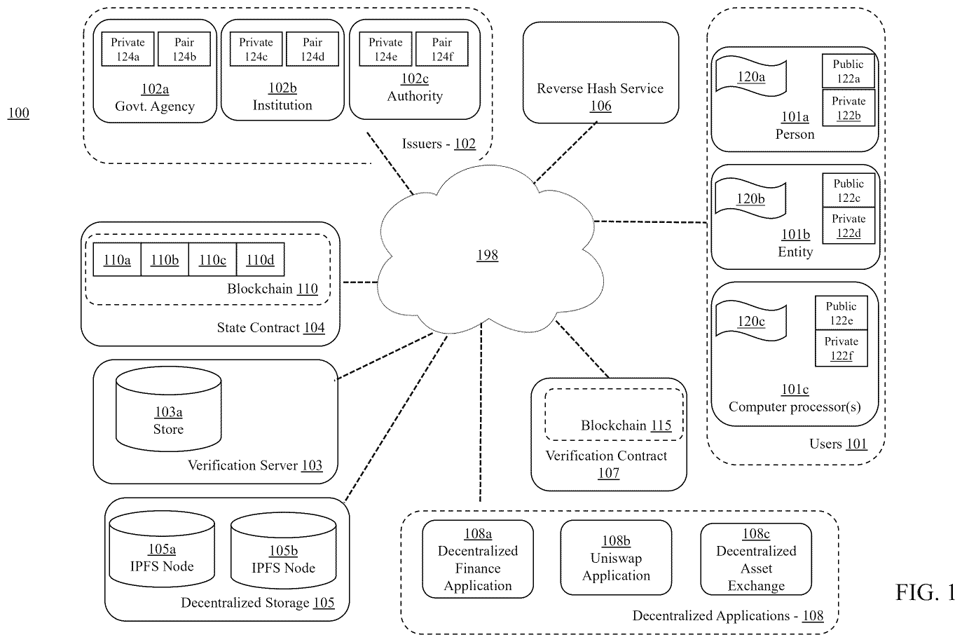

A non-limiting exemplary embodiment of a computing environment 100 for privacy enhanced identify authentication is illustrated in FIG. 1. Computing environment 100 can include users 101, issuers 102, a verification server 103, state contracts 104, a decentralized storage 105 illustrated as IPFS (Inter-planetary file system) 105, a reverse hash service 106, and verification contracts 107. Reverse hash service 106 can be updated by either issuers 102 or users 101 if, for example, a respective revocation tree or a respective roots tree is to be updated. In some embodiments, verification server 103 can reach out to state contracts 104 to update a latest identity state of user and can update verification contracts 107 once verification server 103 verifies a policy proof of an identity.

Users 101 can be any entity capable of receiving and managing claims about users 101. These claims can be about an identity of users 101, qualifications of users 101, or assets owned by users 101. In some embodiments, users 101 possesses a unique user private key that can be used to manage an account on a blockchain, such as an EVM (Ethereum Virtual Machine) chain. With this private key, users 101 can create a transaction, sign the transaction, and publish the transaction to the blockchain. Users 101 can also possess an encryption key, which can be used for decrypting encrypted claims issued by an issuer, e.g., issuers 102. The encryption key can be either randomly generated or derived from the private key. Users 101 can further possess an authentication key pair that can be either randomly generated or derived from the user private key. In some embodiments, the authentication key pair can be on a Baby-Jubjub curve.

A user 101 may be a person 101a, an entity 101b like a business or a trust, or an entity may be a computer 101c acting by its own volition or on behalf of its owner. In each case a user is modelled for interacting with a network application within computing environment 100 in a variety of ways, non-limiting examples of which are a username, a real name, a unique personal identifier, a passport number, an ID card, or any of various biometric data or as a hash generated based on various identity traits, or any combination of these or other similar identifying information, or identity traits. In embodiments, e.g., a user 106c may be represented by a hash created based on internal digital identifiers like a MAC address or a hard drive GUID or combinations thereof or other unique information that reliably identifies a user, e.g., 106c. A user may also be identified by a public/private key pair, e.g., 122a/122b, 122c/122d, 122e/122f. In various embodiments, a user self generates a public/private key pair, while in other various embodiments a public/private key pair is assigned to a user.

Users 101 can control personal data of users 101 and decide how and when to share it with other users and issuers 102. In some embodiments, users 101 can receive claims from issuers 102, which, as discussed further below, can be authorized to create and issue claims. Claims can be received directly from issuers or through third-party intermediaries (not shown). Users 101 can store claims securely in a personal digital wallet 120a, 120b, 120c associated with users 101, e.g., person 101a, entity 101b, or computer processor(s) 101c, respectively. These wallets can provide a tamper-proof and private environment for managing claims. Users 101 can selectively share claims with verifiers, which can be any entity, such as issuers 102, that need to verify specific information about users 101. This sharing can be done directly or through verifiable presentations. Users 101 can further have complete control over claims associated with users 101, which can include control over deciding which claims to store, share, or revoke. Users 101 can also choose to keep certain claims private and not share them with other entities (e.g., other users 101, issuers 102, etc.).

In some embodiments, users may be required to protect their claims and associated private keys to prevent unauthorized access or misuse. This can include, but is not limited to, using strong passwords and secure storage practices to protect their claims and private keys from compromises. Users 101 may also be required to manage their claims effectively, which can include ensuring users 101 have the most up-to-date and accurate information about themselves and their claims. This can involve regularly reviewing and updating claims as needed. Users 101 may further be required to share claims responsibly, which can include only disclosing the minimum amount of information necessary for a specific purpose, and to be aware of the potential consequences of sharing certain claims with other entities, such as other users 101 or issuers 102.

Issuers 102 can be any entity, such as a government agency 102a, an institution 102b, and an authority 102c, that has authority to create and issue claims about other entities, such as users 101. The content of these claims can include information such as, but without limitation, an entity's identity (e.g., an identity of a user 101), qualifications of an entity (e.g., whether a user 101 has a college diploma), or an entity's ownership of an asset. Issuers 102 are responsible for ensuring the accuracy and trustworthiness of the claims that they issue. In some embodiments, issuers 102 each possess a unique master private key, e.g., 124a, 124c, 124e, used to manage an account associated with issuer 102 on a blockchain, such as an EVM chain. Utilizing their private key, issuers 102 can construct transactions, digitally sign transactions, and publish the transactions to the blockchain. Additionally, issuers 102 possess an authentication key pair, e.g., 124b, 124d, 124f, which can either be randomly generated or derived from the master key of the issuer 102. In some embodiments, the authentication key pair of an issuer resides on a Baby-Jubjub curve.

Issuer 102 can create claims about any entity, such as but not limited to user 101, as long as issuer 102 has authority to do so. For example, a government agency 102a may issue claims about the citizenship status of a person 101a, or a university, e.g., an institution 102b, may issue claims about academic credentials of a person 101a, but each may not have authority to issue claims about an annual salary of a person 101a. Issuer 102 also can issue claims to holders, such as an entity 101b, which are entities that the claims are about. Claims can be issued directly to holders, or they can be issued through a third-party intermediary (not shown). Issuers 102 can also revoke claims that they have previously issued. This may be necessary if a claim is no longer accurate or if the holder has violated the terms of the claim. Further, issuers 102 can manage the claims that they have issued, which can include tracking a status of claims (e.g., revoked or unrevoked, accurate or inaccurate) and responding to inquiries from holders and verifiers.

Issuers 102 may also be required to ensure that the claims that they issue are accurate and truthful. This is important to maintain the integrity of computing environment 100. Issuers 102 may also be required to protect the privacy of a user's data, which can include only collecting the minimum amount of data necessary and storing data securely. Issuers 102 may further be required to be transparent about their claim-issuance process, which can include making its policies and procedures publicly available.

A reverse hash service (RHS) 106 can be a privacy-enhancing service within computing environment 100. In some embodiments, RHS 106 can employ a sparse Merkle tree data structure that can efficiently store revocation information for a large number of credentials. Using the sparse Merkle tree, a user, e.g., user 101, can construct proofs of existence or non-existence of one or more elements in the sparse Merkle tree without revealing the specific element of the tree being proven. The user 101 constructing the proof, also known as the prover, can construct a Merkle proof that links a hash of an element to the root of the Merkle tree, proving the element's existence or non-existence within the tree without revealing the element itself. This proof can be verified by a verifier, such as, but not limited to, a verification server 103, without revealing the hash of the element or any other sensitive information related to the element of the prover. This functionality is particularly useful for verifying the revocation status of credentials without disclosing the credential itself, thereby protecting user privacy.

RHS 106 provides valuable capabilities for enhancing privacy in computing environment 100. For example, a user, e.g., user 101, can prove the revocation status of an element without disclosing the element itself, protecting the privacy of the user and preventing unnecessary exposure of sensitive information. In addition, RHS 106 can utilize one or more efficient cryptographic processes and data structures to generate and verify proofs of existence or non-existence of an element, minimizing computational overhead and ensuring scalability. Furthermore, RHS 106 can maintain verifiable revocation lists, ensuring that revocation information is tamper-proof and trustworthy.

Verification server 103 can perform verification of proofs generated by a user for given policies. Verification server 103 can perform this verification off chain, i.e., not on a blockchain. During these verifications, verification server 103 does not learn any sensitive or private information in a policy and only learns the public inputs of the policy requirements. Verification server 103 can first validate the public inputs of the policy requirements of a proof, then verify the proof, off-chain. If the verification succeeds, verification server 103 can submit all verified proofs to a decentralized storage 105 with one or more content identifiers (CIDs) of the data of the proofs and then update the status of an account corresponding to the user who generated the proof with policy verification on verification contract 107. In some embodiments, verification server 103 can use a zero-knowledge (ZK) proof, such as a zkSNARK proof, to verify proofs without learning any private information about the user who generated the proof. The ZK proof is efficient and scalable, allowing verification server 107 to verify proofs quickly and inexpensively.

When a user 101 generates a ZK proof, e.g., a zkSNARK proof, for a specific policy, the ZK proof, along with the necessary public inputs, is sent to verification server 103. Verification server 103 then performs a validation of the public inputs and verifies the proofs off-chain, i.e., not on a blockchain. Once validated, validation server 103 can compute the content identifier (CID) of the data in the ZK proof and submit the ZK proof along with the CID to an IPFS server, e.g., IPFS Node 105. This ensures the secure and decentralized storage of the verification data. Verification server 103 can also submit one or more of an account address of the user 101 who generated the proof, the CID of the data in the proof, the policy ID, an expiration date, and a unique identifier to verification contract 107, which may be a public blockchain. This submission serves as a record of the successful verification and allows other entities to confirm the compliance status of the account of the user without revealing the underlying user data to the other entities confirming compliance status or to the public via writing the underlying user data onto verification contact 107.

Verification server 103 can also store claims from a user 101, in addition to such claims being stored on a wallet of the user. A user 101 can encrypt a signed claim user a wallet master key and send it to verification server 103 to be stored on verification server store 103a. To reconstruct the claim tree, user 101 receives a list of encrypted claims from store 103a of verification server 103. For each encrypted claim, user 101 decrypts the encrypted data to reveal the corresponding signed claims. For each signed claim, user 101 can process the claim data by converting the claim to a readable format and calculating a hash to represent the claim. The user 101 then reconstructs the signature associated with each claim and organizing the processed claim data, the corresponding signatures, and issuer information for each claim in a structured format, such as a Merkle tree, for later use.

Once verification server 103 has verified a proof, it may also submit the proof to decentralized storage 105, e.g., IPFS Node 105a or 105b. This ensures that the proof is publicly available and therefore cannot be tampered with. Finally, verification server 103 can also update a status of an account associated with the user 101 who generated the proof, a.k.a. the prover, with policy verification on verification contract 107. This allows the user to prove that they have met the policy requirements and access the associated resources necessitating the proof.

Decentralized storage 105 employs a content-addressed storage approach, where each file is identified by a unique cryptographic hash that can be referred to as a content identifier (CID). This CID serves as a fingerprint uniquely representing a file's content and enabling tamper-proof storage and retrieval. In some embodiments, decentralized storage 105 comprises IPFS Nodes 105a, 105b of an IPFS (InterPlanetary File System). An IPFS decentralized storage system 105 relies on a content-addressable file system that utilizes cryptographic hashes to locate data across a distributed network of nodes. In IPFS, files are broken down into smaller chunks and identified by their content, rather than their location. This allows for efficient content retrieval and sharing, reducing duplication and enhancing data availability. Publicity, verifiability, and transparency are key benefits of decentralized storage system 105. For example, in embodiments where decentralized storage system 105 is an IPFS, content is publicly accessible, allowing anyone to retrieve and verify the integrity of stored data. This transparency fosters trust and ensures that data remains unaltered. To verify data integrity, an IPFS leverages cryptographic techniques like hash functions and Merkle trees. These mechanisms ensure that any modifications to the original content are readily detectable, preserving data authenticity and preventing tampering.

While illustrated as two nodes 105a and 105b, a person of ordinary skill in the art will appreciate that an IPFS may comprise any number of nodes. It will further be appreciated by a person of ordinary skill in the art that decentralized storage 105 can be any decentralized storage system, such as Arweave and other peer to peer networks. In an Arweave decentralized storage system 105, data may be stored in a tamper-proof manner through a process called permaweb, which leverages cryptographic hashing and consensus decision making. This ensures that once data is stored on the network, it becomes immutable and resistant to censorship. In contrast to traditional cloud storage solutions, Arweave provides an economically incentivized model for participants, encouraging them to store data in a distributed and redundant manner.

State contract 104 is a decentralized ledger, such as a blockchain ledger 110, for storing and managing state information for users. It provides a tamper-proof and transparent mechanism for recording and updating claims, revocations, and other identity information. State contract 104 can store key-value pairs, where each key represents a unique identifier associated with a particular piece of identity data and the corresponding value represents the actual data itself. This actual data represented by the value can include claims, revocations, and metadata. Importantly, the actual data itself is not stored on blockchain 110 of state contract 104 but is instead represented by a unique identifier associated with the data, thus preserving the privacy of the underlying data while confirming the state of a user with respect that particular type of data. As discussed, claims are verifiable statements about an entity's identity, attributes, or credentials, and revocations include records indicating that a particular claim has been revoked or is otherwise no longer valid (e.g., the particular claim has expired temporally). Metadata can include any additional information related to identity management, such as timestamps, signatures, and proofs.

Authorized entities, such as issuers, e.g., issuer 102, and credential owners, e.g., user 101, can update data on state contract 104 by submitting transactions 110a, 110b, 110c, and 110d to the blockchain ledger 110 of state contract 104. These transactions contain instructions that can add new key-value pairs, update existing key-value pairs, or remove existing key-value pairs. State contract 104 can leverage the immutability and tamper-proof nature of blockchain ledger 110 to guarantee the integrity of data stored on the ledger. Once data is written to state contract 104, it becomes part of the permanent record of blockchain ledger 110, ensuring that the data cannot be altered or deleted without consensus.

In some embodiments, state contract 104 can include a global identities state tree (GIST). A GIST is a decentralized and efficient data structure for storing and managing current states of all identities of the data stored on state contract 104. The GIST can be implemented as a sparse Merkle tree with a plurality of leaf nodes, which is a specialized data structure optimized for storing and verifying large sets of data with minimal storage overhead. Each leaf node in the GIST represents the latest state of a particular identity, while intermediate nodes provide cryptographic proofs for efficient verification of identity states.

Verification contract 107 is a decentralized ledger, e.g., a blockchain ledger 115, that maintains statuses of whether an account associated with a user 101 has successfully proven compliance with a given policy. Verification contract 107 can be maintained and updated by verification server 103, ensuring the integrity and validity of the verification process. Verification contract 107 helps facilitate secure and verifiable identity management while maintaining a decentralized and transparent verification process.

In the event that verification server 103 deviates from protocol or acts maliciously, any member of computing environment 100, e.g., user 101 and issuer 102, can retrieve a complete proof from decentralized storage 105 and submit the complete proof to verification contract 107. This mechanism enables identification and repair of a verification server 103 that deviates from protocol or acts maliciously, ensuring overall trustworthiness and reliability of computing environment 100.

In some embodiments, computing environment 100 may also include one or more decentralized applications 108, or dApps, that operate autonomously without a central entity in control. The dApps can help maintain the data stored on state contract 104 and verify whether claims from a user 101 satisfy certain policies. Users can create claims to request access to dApp 108, and dApp can check state contract 104 to determine whether a user's claim satisfies a policy in order to access dApp 108. dApps 108 can include, but are not limited to, decentralized finance application 108a, Uniswap application 108b, and decentralized asset exchange 108c.

One will appreciate that each aspect of the decentralized network application environment 100 may be network reachable by each other aspect of environment 100 via a network 198, e.g., the Internet. But, it will also be appreciated that certain aspects are only reachable via private networks without departing from the scope of this disclosure. For example, an institution 102b, e.g., a finance institution, may issue a person user 101a an account associated with an account ID and certain account information that the person 101a may access with a username and password or other credentials. In other cases, aspects may only communicate via non-electronic means. For example, an authority 102c, e.g., a utility authority, may issue a person 101a a bill bearing an account number associated with an address and an account standing, or a credit authority may maintain a credit report about a business entity 101b.

Computing environment 100 shown in FIG. 1 provides a privacy-enabled self-sovereign identity. This self-sovereignty extends to the issuance of claims, enabling an identity to assert verifiable information about another identity, whether it be an individual, an organization, or a system/machine.

As used herein, a claim refers to an ordered, structured piece of information representing a verifiable statement made by one identity about another identity or about the claim itself. A claim may be presented as (C_{IK}, C_{Vk}) where C_{IK} is c claim index representing a kth index slot and C_{Vk} is a claim value representing a kth value slot. In some embodiments, k=1, . . . 4 and 0≤C_{IK}, and C_{Vk}≤2253. A claim schema, which can be 128 bits in length, can be placed in the C_{I0} index slot, and a revocation nonce and an expiration date, each 64 bits in length, can be placed into the index slot C_{V4}.

Each claim also can have its own index hash C_{Hi} and value hash C_{Hv} which may be computed according to: C_{Hi}=Poseidon(C_{I0}, C_{I1}, C_{I2}, C_{I3}), and C_{Hv}=Poseidon (C_{V0}, C_{V1}, C_{V2}, C_{V3}).

A claim can be issued by an issuer 102, e.g., government agent 102a, institution 102b, or authority 102c through signing or managing a Merkle Tree. When issuing a claim, an issuer can utilize an EdDSA signature scheme on a Baby Jubjub curve with MiMC-7 hashing, as discussed previously.

Claims may be stored on the leaves of a Merkle tree (MT) to ensure data integrity and tamper-proof quality. The index element of a claim serves as a unique identifier for the claim and is used to determine the specific leaf position within the Merkle tree where the claim's value will be stored. The value part of a claim contains the actual information being asserted about the identity, e.g., about a user 101. They can be classified into two categories, static claims and dynamic claims. Static claims can include immutable information that cannot be changed once they are issued. Examples of static claims include, but are not limited to, name, surname, citizenship, and birthday. Dynamic claims can include information that is not immutable and that can be updated or revoked over time. Examples of dynamic claims include, but are not limited to, authentication key, salary, college degree, and a membership in a club.

In some embodiments, dynamic claims can possess additional attributes, such as an expiration date or a revocation nonce. An expiration date specifies when a corresponding claim is no longer valid, while a revocation nonce is a unique identifier that can be used to revoke a corresponding claim.

To ensure immutability of claims, a special transition validation function (FTV) can be employed in to restrict how leaves are stored on a claim tree Merkle tree. The special FTV can be used to enforce an append-only mechanism, meaning that new claims can be added to the tree, but existing claims cannot be modified or deleted from the tree. This immutability guarantees integrity and authenticity of claims over time. Any element in environment 100 utilizing a Merkle tree, such as state contract 104, can employ a special FTV.

Any proofs of claims may only be generated with explicit consent from the identity owner. This can be done by either digital signatures or by adding the claims as leaves of a Merkle tree already stored on a blockchain network. This protection prevents unauthorized parties from making claims or assertions on behalf of an identity without their knowledge or approval.

Claims are also designed to be adaptable to changing circumstances. Thus, claims can be revoked, which effectively invalidates their authenticity and prevents their further use. Once revoked, a claim can no longer be used for verification or proof generation.

To provide granular control over claim updates, a flag can be set to indicate whether a claim is updatable or not. This flag enables identities, such as a user 101, to selectively restrict updates to specific claims, ensuring that only authorized claims can be modified over time.

To reflect changes in an identity's attributes or credentials, claims can be updated by creating new versions. Each version represents a distinct state of the claim, conveying a clear history of modifications. However, once a claim is revoked, no further versions can be created, ensuring that revoked claims cannot be revalidated. While only updatable claims can have different versions, each version of a claim shares the same revocation nonce value. Furthermore, only the latest version will be considered valid, while older versions will be considered revoked.

As used herein, a policy refers to a collection of one or more queries that define an ordered set of a relationship. A query is a cryptographic challenge that can be used to verify whether a specific claim satisfies a particular mathematical relationship. This mathematical relationship can be expressed as, for example, a comparison operation, such as less than, greater than, equal, in, or not in. For example, a query might as whether a user's salary is less than $10,000, whether a user's age is greater than 18, or whether a user's citizenship is not included in a specified list of citizenships. Each query within a policy can target a distinct claim and evaluate the distinct claim against a specific mathematical operation. In this way, policies may be constructed of one or more queries corresponding to respective claims, such that each policy may be regarded as containing one or more claims as well.

To illustrate the distinction between queries and policies, consider the following examples:

Query: Verify whether a client's salary is less than $10,000. Namely, the query focuses on a single claim (salary) and checks whether it meets a specific condition (less than 10,000); and

Policy: Verify that a client's salary is less than $10,000 and their age is greater than 18. Namely, the policy combines two queries, each targeting a different claim (salary and age) and enforces both conditions simultaneously.

In this way, queries serve as building blocks for policies, enabling construction of complex and nuanced access control mechanisms. By combining multiple queries, policies can effectively express a wide range of requirements and ensure that only authorized individuals are allowed access to services based on satisfying or not satisfying a set of one or more claims.

Digital identity framework utilizes claims issued by an identity, such as by a user 101, that can be cryptographically proven and verified, ensuring the claims' existences under the identity at a specific timestamp. To achieve this, identities can be constructed using Merkle trees, where claims reside in the leaves of the Merle trees, and the root of the Merkle tree is published indirectly through an identity state on a Blockchain. This construction enables identities to issue, update, and revoke claims.

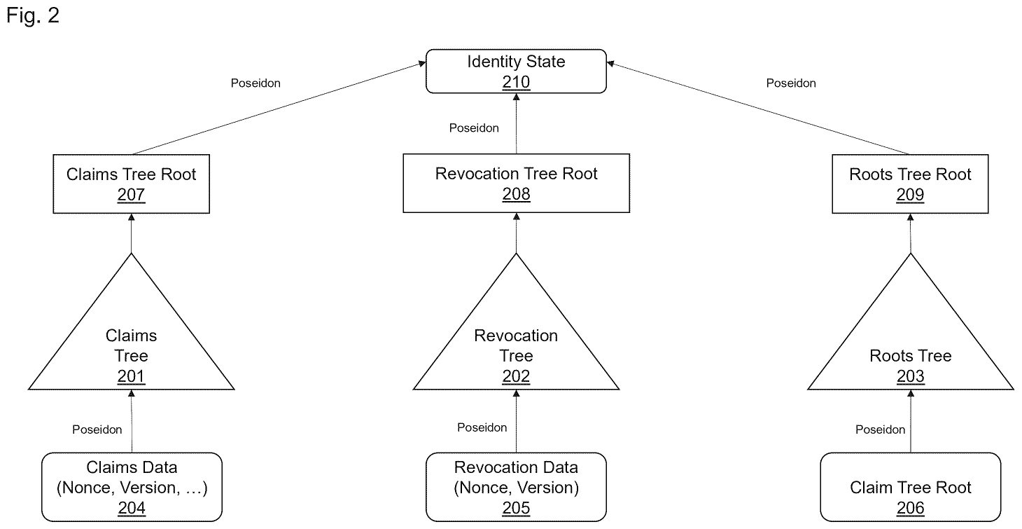

As illustrated in FIG. 2, different sparse Merkle trees may be used to construct identities, which can include a claim tree 201 (claimTree), a revocation tree 202 (revocTree), and a roots tree 203 (rootTree). Claim tree 201 is an append-only sparse Merkle tree that stores claims in its leaves, revocation tree 202 is an append-only sparse Merkle tree that stores unique revocation numbers in its leaves, and roots tree 203 can be an append-only sparse Merkle tree that stores the roots of previous claim trees. A Poseidon hash of claim data 204, which can include sensitive information about the user, is stored in the leaves of claims tree 201. Claim data 204 and claims tree 201 are kept private from the rest of the entities in computing environment 100 and may be maintained by a user 101, an issuer 102, and/or a dApp 108. A Poseidon hash of revocation data 205, which includes a nonce value and version identifier, are stored in revocation tree 202. A Poseidon hash of claim tree roots 206 of claim tree 201 are stored in a roots tree 203. Both revocation tree 202 and roots tree 203, including revocation data 205 and claim tree roots 206, are publicly available on computing environment 100 and may be maintained by a reverse hash service, e.g., RHS 106. RHS 106 can be queried by other entities in computing environment 100, such as users 101, issuers 102, verifier server 103, and dApps 108. A Poseidon hash of the root of each of claims tree 201, revocation tree 202, and roots tree 203 is then taken, e.g., roots 207, 208, and 209, and those hash values are used to determine an identity state 210. The identity state can be stored on a blockchain, such as on state contract 104 and/or verification contract 107, and/or on a Merkle tree stored in RHS 106. The roots 207, 208, and 209 of each tree and their Poseidon hashes are also publicly available on computing environment 100, e.g., on RHS 106. These roots can be obtained by querying RHS 106 for the latest identity state of a user.

Initially, Merkle trees 201, 202, and 203 are empty. Each identity corresponding to a user 101 is assigned a unique identifier, referred to as a Genesis ID, which can be derived from an initial identity state, which can be a hash of the Merkle Tree roots of the initial identify state. One or more initial claims, which may be contained in the identity's initial state, are placed under this Genesis ID. The GenesisID can include an authentication claim, which includes a public address of a private-public key pair randomly generated from a master private key of the user corresponding to the identify state, and a blockchain address claim. Each of the authentication claim and the blockchain address claim can include a respective unique random revocation nonce and a respective updatable flag. In some embodiments, the private-public key pair randomly generated from a master private key of the user is a Baby Jubjub key pair. In some embodiments, the blockchain address claim is an Ethereum address claim.

After constructing initial sparse Merkle trees, the GenesisID identity state can be computed using a Poseidon hash of each root of each Merkle tree according to identityState=poseidon. Hash (claimTree.Root, revocTree.Root, rootTree.Root). The claims of the GenesisID identity state of can be directly verified against the Genesis ID because the Genesis ID is constructed from the root of the Merkle tree that holds those claims (e.g., claimTree). In some embodiments, Genesis ID may be formatted as Genesisld=base58Encoding {type| genesis state| checksum}, where type has a length of 2 bytes, genesis state corresponds to a first 27-bytes of the Gensis ID identity state, and checksum is a 16-bit checksum taken over type and genesis state.

Note that an identity state, e.g., the GenesisID identity state, is published on a blockchain, e.g., state contract 104 and/or verification contract 107. Similarly, revocation tree 202 and roots tree 203 may be published publicly, such as on the respective blockchain of state contract 104 and/or verification contract 107, in order to verify whether a claim is issued or revoked. The claims themselves, however, that are contained in leaves of claim tree 201 remain private to the owner of the claim, e.g., a user 101, and any trusted party issuers, e.g., issuers 102. However, the roots 207, 208, and 209 of claims tree 201, revocation tree 202, and roots tree 203, respectively, are all publicly available and are needed during generation and/or verification of a proof. These roots do not include any private information about the claim because they are merely an output of various hash functions taken through the leaves of the tree until there is only one value left, corresponding to the root of the tree.

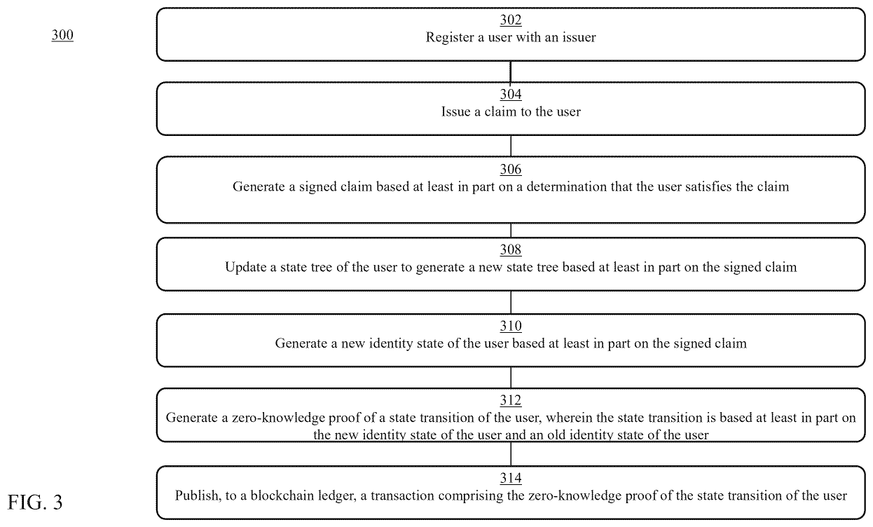

A method 300 for proving a claim is described with reference to the flowchart illustrated in FIG. 3. First, at step 302 a user is registered with an issuer.

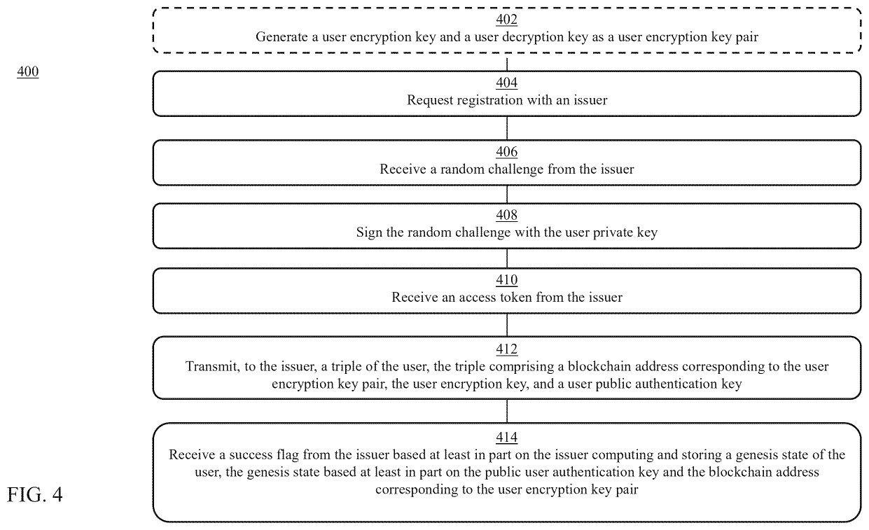

A method 400 for registering a user with an issuer is described with reference to FIG. 4. At step 404, a user requests to register with an issuer. This can include a user, e.g., a user 101, communicating to an issuer, e.g., issuers 102, a request to register with issuers 102. Prior to requesting to register with an issuer, method 400 may include the optional step 402 of generating a user encryption key and a user decryption key as a user encryption key pair. Step 402 is optional because a user may already possess a user encryption key and a user decryption key, and components required in their generation, and therefore may not need to generate them prior to performing step 404.

Step 402 may include a user, e.g., user 101, generating an ECDSA key pair (Uₛₖ, Uₚₖ) that includes a user public key Uₚₖ and a user private key Uₛₖ, and a corresponding public blockchain address Uadd of the key pair. In some embodiments, the corresponding public blockchain address is a public Ethereum address of the key pair. Step 402 can further include the user generating a Baby Jubjub-based user authentication key pair (Auth_{Upk}, Auth_{Usk}), derived from the user private key and the user public key, used for authentication purposes in a zero-knowledge proof. In some embodiments, the user authentication key pair is derived. If m is a fixed message to be deterministically signed by a user, user can compute a signature=Sign_{Usk} (m). Next, U can compute Auth_{Usk}=SHA512 (signature) [: 32]. User U can then compute Auth_{Upk}=Auth_{Usk}*G, where G is the base point of the Baby Jubjub curve. Deriving a key is beneficial because users are not expected to store the authentication keys, which can be impracticable given storage and tracking limitations of users. In some embodiments, the user public key Uₚₖ may be used to identify the user during a transaction or other communication with other entities, such as an issuer or a verifier server.

Step 402 can further include the user generating a user encryption key and a user decryption key, denoted as (U_{enc}, U_{dec}), respectively, as a user encryption key pair. The user encryption key U_{enc} is a public key derived by scalar multiplication of a base point on the Baby Jubjub curve of the user authentication key pair, such as Curve25519, and user decryption key U_{dec}. Namely, U_{enc}=U_{dec}×G₂, where G₂ is the base point of the Baby Jubjub curve, such as Curve25519. User decryption key U_{dec} can be generated randomly or derived from the user private key Uₚₖ.

In some embodiments, an issuer, e.g., issuers 102, also generates an ECDSA issuer key pair (Iₚₖ, Iₛₖ) that includes an issuer public key Iₚₖ and an issuer private key Iₛₖ, and a public blockchain address I_{add} denoting a corresponding public blockchain address of the issuer key pair. In some embodiments, the corresponding public blockchain address is a public Ethereum address of the key pair. Then, an issuer authentication key pair (Auth_{Ipk}, Auth_{Isk}) can be derived following the same steps used to derive the user authentication key pair. Alternatively, the issuer authentication key pair can be randomly generated. In some embodiments, an issuer public key Iₚₖ may be used to identify an issuer during a transaction or other communication with other entities, such as a user or a verifier server.

Returning the method 400 in FIG. 4, step 406 includes receiving a random challenge from the issuer. In step 406, the user can receive a random challenge from the issuer with instructions to complete the random challenge by signing the random challenge. In some embodiments, the issuer generates the random challenge nonce, such as rcεR{0, 1}²⁵³, to be signed by the user and transmits the random number challenge to the user based on the issuer receiving the registration request from the user. Next, at step 408, the user signs the random challenge nonce with the user private key Uₛₖ by computing signature=Sign_{Usk} (rc). Once the random challenge is cryptographically signed, the user transmits the signature back to the issuer and the issuer verifies the signature to authenticate the user with the user public key Uₚₖ. If the user signature is verified and the user authenticated, step 410 is executed, and the user receives an access token from the issuer. This can include issuer transmitting a JSON Web Token or other digital token to the user. In some embodiments, the access token is applicable to the current session between the issuer and the user and is only usable in that current session. The access token can include information such as an identifier of the issuer, an identifier of the user, an expiration time, an issued-at time, session-specific details (e.g., a session identifier), scopes or permissions of the access, and any custom claims required for the session. It is cryptographically signed by the issuer to ensure integrity and authenticity.

At step 412, the user transmits a triple of the user encryption key U_{enc}, the blockchain address of the user key pair U_{add}, and the user public authentication key Auth_{Upk} to the issuer. Step 412 can further include the user generating the triple as (U_{enc}, U_{add}, Auth_{Upk}). Next, at step 414, the user can receive a success flag from the user, the success flag being based at least in part on the issuer computing and storing a genesis state of the user, the genesis state based at least in part on the public user authentication key and the blockchain address corresponding to the key pair of the user. Upon receipt of the triple transmitted in step 412, the issuer computes a genesis state for user U based on the blockchain address of the user key pair U_{add}, and the user public authentication key Auth_{Upk} according to U_{genesis}=ComputeGenesis (U_{add}, Authᵤₚₖ). Once the genesis state of the user is generated, the issuer stores the genesis state of the user and the triple in a (U_{genesis}, U_{enc}, U_{add}, Auth_{U}pk) in a local database and transmits a success flag to the user. The success flag signals to the user that the user has successfully registered with the issuer.

With reference to FIG. 3, method 300 further includes step 304 of issuing a claim to the user. This step can include an issuer, e.g., issuers 102, transmitting a claim to a user, e.g., user 101. Each type of claim may require different user data to validate the claim. For example, a claim for name, surname, and birthday may require the user's ID card, passport, or driver's license, while a claim for a college degree may require a valid diploma. In some embodiments, the user maintains a claim tree (claimTree), a revocation tree (revocTree), and a roots tree (rootsTree).

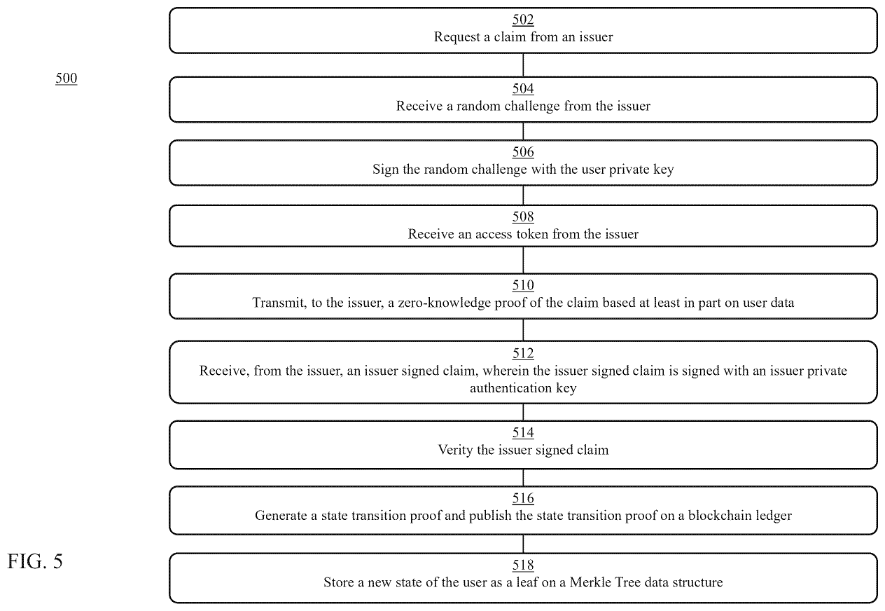

A method 500 for issuing a claim to a user is described with reference to FIG. 5. Method 500 begins with step 502 of the user requesting a claim from the issuer. This can include the user transmitting a request to an issuer for the issuer to issuer a claim to the user. The request can include, but is not limited to, an identifier of the user such as a user ID or an address of the user, and a claim index of the requested claim, e.g. (U.address, claimIndex) to issuer. At step 504, the user then receives a random challenge from the issuer. This can include the issuer generating a random challenge nonce, such as rcεR{0, 1} ²⁵³ and transmitting it to the user for signature. Next, at step 506, the random challenge is signed with a user private key. This can include the user signing the random challenge rc received from the issuer with the user private key Uₛₖ according to signature=Sign_{Usk} (rc) and transmitting the signature to the issuer. Upon receipt of the signature from the user, the issuer can verify the signature of the random challenge rc signed by the user with the user public key Uₚₖ in order to authenticate the user. Verifying the user's signature may involve the issuer comparing the received signature to a reference signature stored by the issuer. If the received signature matches the stored reference, the signature is considered valid and successfully verified.

At step 508, an access token is received from the issuer. This can include issuer transmitting a JSON Web Token or other digital token to the user. In some embodiments, the access token is applicable to the current session between the issuer and the user and is only usable in that current session. The access token can include information such as an identifier of the issuer, an identifier of the user, an expiration time, an issued-at time, session-specific details (e.g., a session identifier), scopes or permissions of the access, and any custom claims required for the session. It is cryptographically signed by the issuer to ensure integrity and authenticity. At step 510, the user sends user data corresponding to the claim value of the claim to the issuer. This can include the user providing data in the form of plaintext to the issuer, such as the user's name, home address, age, etc. In some embodiments, the user may further transmit evidence of the corresponding user data, such as an image of the user's passport or other document containing the user data corresponding to the claim value of the claim. Upon receipt of the user data, the issuer can verify whether the user satisfies the claim. This can include the issuer comparing the user data to the claim value and determining whether the user data satisfies the claim value. For example, if the claim value is over 18 years old, the issuer can check the user data for the age of the user, and if the age of the user is over 18, the issuer determines that the user satisfies the claim. If the user satisfies the claim, the issuer signs the claim with the issuer private authentication key signature=Sign_{AuthIsk} (claim) to generate an issuer signed claim. The issuer then transmits the signature to the user. At step 512, the issuer signed claim is received by the user.

At step 514, the issuer signed claim is verified with the issuer's public key using a cryptographic signature scheme, such as but not limited to ECDSA. This can include the user verifying the signature, i.e., SignAuthIpk (claim), of the issuer on the claim. User can first call stateTreeoid=(state old, claimsRoot_{old}, revocRoot_{old}, rootsRoot_{old}), which represents the identify state of the user at the time of claim verification but before the state transition proof is generated. Here, state_{old} is computed according to state_{old}=ComputeState (claimsTree_{old}, revocTree_{old}, rootsTreeold), and claimsRoot_{old}, revocRoot_{old}, and rootsRoot_{old} correspond to the current root of each of the user's claimsTree, revocTree, and rootsTree, respectively, at the time of claim verification but before the state transition proof is generated. ComputeState (claimTree, revocTree, rootTree) calculates and returns poseidon. Hash (claimTree.Root, revocT ree.Root, rootT ree.Root).

At step 516, a state transition proof is generated and the state transition proof is published on a blockchain ledger. This can include updating the user's claimsTree, e.g., claim tree 201, as claimsTree_{new} by adding a new leaf corresponding to the signed claim to the user's claim tree. This user also updates a rootsTree, e.g., root tree 203, of the user as rootsTree_{new} by adding a new leaf corresponding to the current root of claimsTree_{new} of the user to the user's rootsTree. The user also computes a new state tree according to stateTree_{new}=(state_{new}, claimsRoot_{new}, revocsRoot_{new}, rootsRoot_{new}), where state new is the user's identity state based on the user's updated claim tree, claimsTree_{new}, and the user's updated roots tree, rootsTree_{new}, and is determined according to, state_{new}=ComputeState (claimTree_{new}, revocTree_{new}, rootTree_{new}.). The user then determines whether the validated authentication claim authClaimᵥₐₗ is on the user's claimTree by computing authMTPProof according to GenMProof (claimTree_{old}, authClaimᵥₐₗ, state Tree_{old}.claimsRoot), where GenMProof (tree, entry, rootKey) generates a proof of the existence of an entry's hash index in a Merkle tree, given the root, and authClaimᵥₐₗ is validated authentication claim of the user. Next, the user generates a proof of whether the revocation nonce of the validated authentication claim authClaimᵥₐₗ exists on revocTree_{old} by computing authNonRevMTPProof according to GenNonRevMProof (revocTree_{old}, authClaim.revNonce, state Tree old. revocRoot). GenNonRevMProof (tree, entry, rootKey) generates a proof of the non-existence of an entry's hash index for a Merkle tree, given the root. Here, authClaim.revNonce corresponds to the revocation nonce of the validated authentication claim of the user authClaimᵥₐₗ. Next, user U generates a proof, called authClaimNewStateIncMtp=GenMProof (claimTree_{new}, authClaimᵥₐₗ, stateTree_{new}.claimsRoot), to ensure that the authorization claim's is included in the new state.

The user then generates a zkSNARK proof for the state transition by calling StateTransitionProof, which generates a zero-knowledge proof of the identity state transition from the old identity state to the new identity state. Determining StateTransitionProof is based on the valid authentication claim authClaimᵥₐₗ, a proof of the existence of the authClaimᵥₐₗ on the user's claimTreeod, e.g., authMTPProof, a proof of the non-existence of a revocation nonce of authClaim on the identity, e.g., authNonRevMTPProof, and a signature of the hash of the old identity state and the new identity state using the user's private key (SignAuthUsk (hash (oldstate, newstate))). In some embodiments, determining StateTransitionProof is based on the following parameters: authClaimᵥₐₗ, state old, state_{new}, Sign Auth_{Usk} (state old, state new.), authMTPProof, authNonRevMTPProof, and authClaimNewStateIncMtp.

Once the zero-knowledge proof of the state transition is determined, the user publishes a transaction on a blockchain ledger, e.g., state contract 104, that includes zero-knowledge proof of the identity state transition to update the user's identity state on the state contract 104. In step 518, the new state if the user is then saved as a new leaf of a Merkle tree. This can include the user storing (state_{new}, claimRoot, revocRoot, rootRoot) as a new leaf on a Merkle tree of identify states on RHS 106. The user can also update a roots tree, e.g., roots tree 203 on RHS 106 and/or a local database of the user corresponding to the user.

In some embodiments, state contract 104 can verify the zero-knowledge proof of the state transition when the user publishes it on the blockchain ledger of state contract 104. This step can include state contract 104 cross-checking the proof with a trusted state root in a Merkle tree corresponding to the user, such as by querying RHS 106 for the root of a Merkle tree corresponding to the user. In some embodiments, state contract 104 reconstructs a Merkle tree root of the received identity state transition proof and compares it to a stored state root corresponding to the user. If the reconstructed Merkle tree root matches the stored state root, then the proof is valid. If the reconstructed Merkle tree root does not match the stored state root, then the proof is invalid and the state contract 104 will reject the proof. Additional data may be considered in verifying the received proof, including but not limited to, a signature or a block header. Once the received proof is verified, the state of user U is updated in state contract 104. In some embodiments, this can include updating a GIST tree in state contract 104.

Existing claims can also be updated. To update an existing claim, the existing claim may include an updatable flag set to true. The updatable flag can be a Boolean flag that indicates whether the claim can be updated. This updatable flag can be set by the issuer of the claim when the claim is created. If the flag is set to true, the claim can be updated by the user at any time. If the flag is set to false, the claim cannot be updated. Further, an existing claim cannot be updated it is has been previously revoked. Because the issuer of a claim is the entity that created and signed the claim, a user can only update a claim with consent of the issuer that created and signed the claim. When a claim is updated, a new leaf corresponding to the updated claim is added to a claim tree. This new leaf can include an increased version number corresponding to the claim. The previous version of the claim remains as an entry on the Merkle tree and is unchanged. In some embodiments, a leaf can also be added to a corresponding revocation tree containing a revocation nonce and an indication of a highest invalid version of the claim. This indicates that all claims with the same revocation nonce and a version number equal to or lower than the one in the highest invalid version are invalid. The same revocation nonce from the leaf on the Merkle tree corresponding to the previous version number is used in the new claim with the increased version number. This process ensures that there is always only one valid version of a claim at a time.

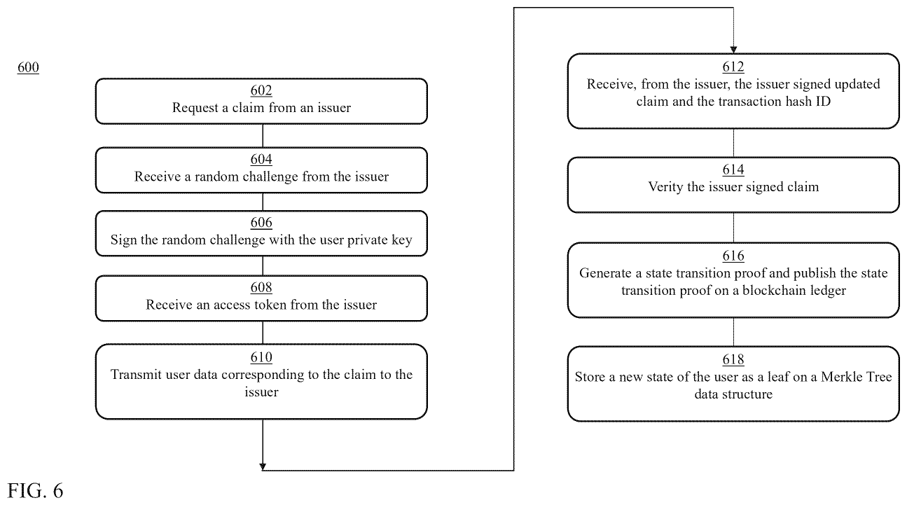

A method 600 for updating a claim is described with reference to FIG. 6. At step 602 of method 600, a user, e.g., user 101, requests a claim from an issuer, e.g., issuer 102, the request specifying the claim to be updated, such as by including the claim index of the requested claim, and an increased version number of the claim. In some embodiments, the request further includes a user identifier corresponding to the user. The issuer can then determine whether the claim is updatable by checking the claim for an updatable flag. This can include the issuer querying a revocation tree, e.g., a revocation tree stored in RHS 106, of the user to determine whether the claim with the corresponding claim index includes an updateable flag. If the claim includes an updatable flag set to true, then the claim can be updated. If the claim includes an updateable flag set to false, then the claim cannot be updated. The issuer further determines whether the claim has been previously revoked by checking the claims for a revocation nonce. If the claim has an updatable flag set to true and the claims has not previously been revoked, then the issuer I can generate a new random challenge nonce and transmit the new random challenge nonce to the user. At step 604, the random challenge nonce is received from the issuer. At step 606, the random challenge nonce is signed with the user private key of the user. This can include the user signing the random challenge nonce re with the user private key Uₛₖ by computing signature=Sign_{Usk} (rc). Once the random challenge nonce is signed, the user transmits the signature back to the issuer and the issuer verifies the signature with the user's public key to authenticate the user. If the user signature is verified and the user authenticated, step 608 is executed and an access token is received from the issuer. This can include the user receiving a JSON Web Token or other digital token transmitted by the issuer. In some embodiments, the access token is applicable to the current session between the issuer and the user and is only usable in that current session. The access token can include information such as an identifier of the issuer, an identifier of the user, an expiration time, an issued-at time, session-specific details (e.g., a session identifier), scopes or permissions of the access, and any custom claims required for the session. It is cryptographically signed by the issuer to ensure integrity and authenticity. At step 610, the user sends user data corresponding to the claim value of the claim to the issuer and instructions for the issuer to update the claim value of the claim.

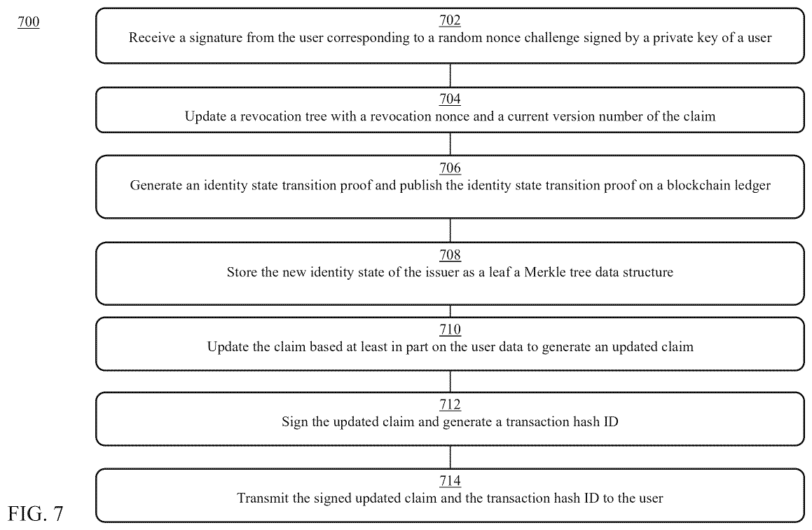

A method 700 of generating a transaction hash ID is discussed with reference to FIG. 7. At step 702, an issuer, e.g., issuer 102, receives user data, instructions for the issuer to update the claim value of the claim based on the user data, and a signature from the user corresponding to a random challenge nonce, e.g., random challenge nonce rc, signed by a private key of the user, e.g., user private key Uₛₖ. At step 704, a revocation tree of the user can be updated. This can include the issuer adding a revocation nonce and a current version number of the claim as a new leaf to a revocation Merkle tree, e.g., recovTree, corresponding to the user stored in RHS 106. At step 706, a state transition proof corresponding to the claim update is generated and published on a blockchain ledger, e.g., state contract 104, to update a state of the issuer. This can include the issuer generating a zero-knowledge proof corresponding to the change of identity state of the issuer from prior to updating the issuer's revocation tree to after the issuer's revocation tree is updated. At step 708, the issuer can store the new identity state of the issuer in a Merkle tree. This can include the issuer adding a leaf to a Merkle tree of the user corresponding to the new identity state of the user, which is determined according to state new={state, claimRoot, revocRoot, rootRoot}. In some embodiments the Merkle tree is stored on a reverse hash service, e.g., RHS 106. In some embodiments, the issuer further publishes the new state to a revocation tree of the RHS. At step 710, the issuer can update the claim to generate an updated claim. This can include the issuer updating the claim value in the claim based, at least in part, on the user data and generating an updated claim with the updated claim value. At step 712, the issuer can sign the updated claim and generate a transaction hash ID, which is a unique identifier representing the updated claim at step 716. This can include the issuer signing the updated claim with the issuer private authentication key according to signature=Sign_{AuthIsk} (claim) to generate an issuer signed updated claim. At step 714, the issuer transmits the signature of the updated claim and the transaction hash ID of the updated claim to user. This can include the issuer transmitting the issuer signed updated claim and the transaction hash ID to the user.

Returning to FIG. 6, at step at step 612, the issuer signed claim is verified using the public key of the issuer. This can include the user verifying the signature, i.e., Sign_{AuthIsk} (claim), of the issuer on the claim. The user can call stateTree_{old}=(state_{old}, claimsRoot_{old}, revocRoot_{old}, rootsRoot_{old}), which represents the identify state of the user prior to the claim updated. Here, state old is computed according to state_{old}=ComputeState(claimsTree_{old}, revocTree_{old}, rootsTree_{old}), and claimsRoot_{old}, revocRoot_{old}, and rootsRoot_{old} correspond to the current root of each of the user's claimsTree, revocTree, and rootsTree, respectively, at the time of claim verification but before the state transition proof is generated.

At step 614, a state transition proof is generated and the state transition proof is published on a blockchain ledger. This can include the user updating the user's claimsTree, e.g., claim tree 201, by adding a new leaf corresponding to the issuer signed updated claim to the user's claim tree to generate claimsTree_{new}. The user also updates a rootsTree, e.g., roots tree 203, of the user by adding a new leaf corresponding to the current root of claimsTree_{new} of the user to the user's rootsTree to generate rootsTree_{new}. The user also computes a new state tree according to state Treenew=(state_{new}, claimsRoot_{new}, revocsRoot, rootsRoot_{new}), where state_{new} is the user's identity state based on the user's updated claim tree, claimsTree_{new}, and the user's updated roots tree, rootsTree_{new}, and is determined according to, state_{new}=ComputeState (claimTree_{new}, revocTree, rootTree new.). The user then generates a proof to ensure that the validated authentication claim authClaimᵥₐₗ corresponding to the updated claim is on the user's claimTree by computing authMTPProof according to GenMProof (claimTree_{old}, authClaimᵥₐₗ, state Tree old.claimsRoot), where and authClaimᵥₐₗ is the validated authentication claim of the user corresponding to the updated claim. Next, the user generates a proof to ensure that the revocation nonce of the validated authentication claim auth Claimval corresponding to the updated claim does not exist on revocTree by computing authNonRevMTPProof according to GenNonRevMProof (revocTree, authClaim.revNonce, stateTree old. revocRoot). Here, authClaim.revNonce corresponds to the revocation nonce of the validated authentication claim of the user authClaimᵥₐₗ corresponding to the updated claim. Next, user U computes authClaimNewStateIncMtp by calling GenMProof (claimTree_{new}, authClaimᵥₐₗ, stateTree_{new}.claimsRoot) to ensure that the authorization claim is included in the new identity state of the user.

The user then generates a zkSNARK proof for the state transition by calling StateTransitionProof, which generates a zero-knowledge proof of the identity state transition from the old identity state to the new identity state. Determining StateTransitionProof is based on the valid authentication claim authClaimᵥₐₗ corresponding to the updated claim, a proof of the existence of the authClaimᵥₐₗ on the user's claimTree_{old}, e.g., authMTPProof, a proof of the non-existence of a revocation nonce of authClaim on the identity, e.g., authNonRevMTPProof, and a signature of the hash of the old identity state and the new identity state using the user's private key (SignAuthUsk (hash (oldstate, newstate))). In some embodiments, determining StateTransitionProof is based on any number of: authClaimᵥₐₗ, state_{old}, State_{new}, SignAuthUsk (state_{old}, state new:), authMTPProof, authNonRevMTPProof, and authClaimNewStateIncMtp.

Once the zero-knowledge proof of the state transition is determined, the user publishes a transaction on a blockchain ledger, e.g., state contract 104, that includes zero-knowledge proof of the identity state transition to update the user's identity state on the state contract 104. In step 618, the new state if the user is then saved as a new leaf on a Merkle tree of the user's identity states. This can include the user storing (state_{new}, claimRoot, revocRoot, rootRoot) as a new leaf on a Merkle tree of user's identify states on RHS 106. The user can also update a roots tree, e.g., roots tree 203, on RHS 106 corresponding to the user.

As discussed herein, claims can also be revoked. In some embodiments, a user may request to revoke a claim, for example, if the user no longer wants its proof of a claim to be used again. In other embodiments, a claim may have an expiration date, and when that date passes, an issuer updates its revocation tree by, for example, adding a revoke nonce of the claim. In both instances, the user state is updated to reflect the revocation of the claim.

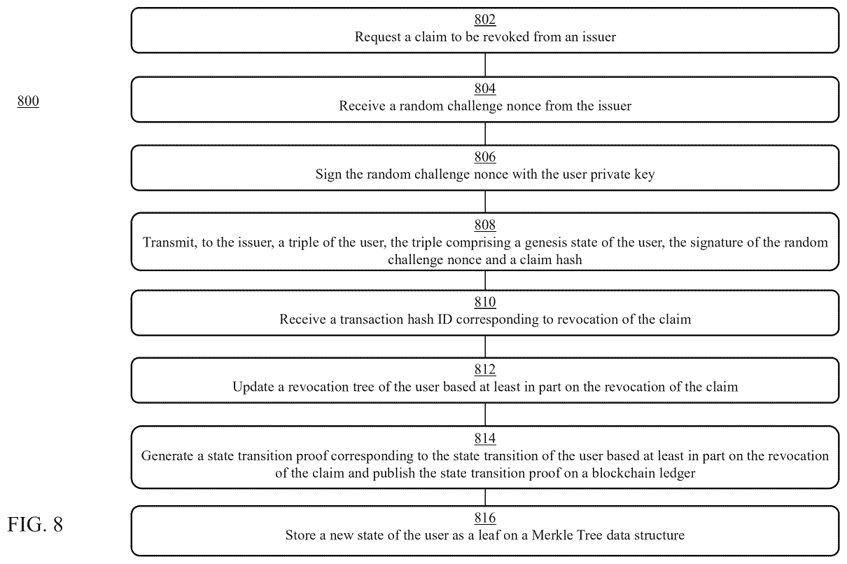

A method 800 for claim revocation is described with reference to FIG. 8. At step 802, a user, e.g., users 101, requests to revoke a claim. This can include the user transmitting a request to an issuer, e.g., issuers 102, of a claim that the user wants to revoke. The request can include, for example, an identifier of the user, such as a user ID or an address of the user, and a claim index of the claim the user wants to revoke. The request may be represented as (U.address, claimIndex). At step 804, the random challenge nonce is received from the issuer. At step 806, the random challenge nonce is signed with the user private key of the user. This can include the user solving the random challenge nonce rc by signing the random challenge nonce and a Poseidon hash of the element inside the claim to be revoked, e.g., claimHash, with the user private key Uₛₖ, computing signature=Sign_{Usk} (rc, claimHash). At step 808, the user transmits a triple of a genesis state of the user, the signature of the random challenge nonce and the claimHash, and the revocation nonce of the claim to be revoked, e.g., (genesisState, signature, revocNonce), to the issuer. Upon receipt of the triple from the user, the issuer can update an issuer revocation tree and generate a transaction hash ID based on the revocation of the claim.

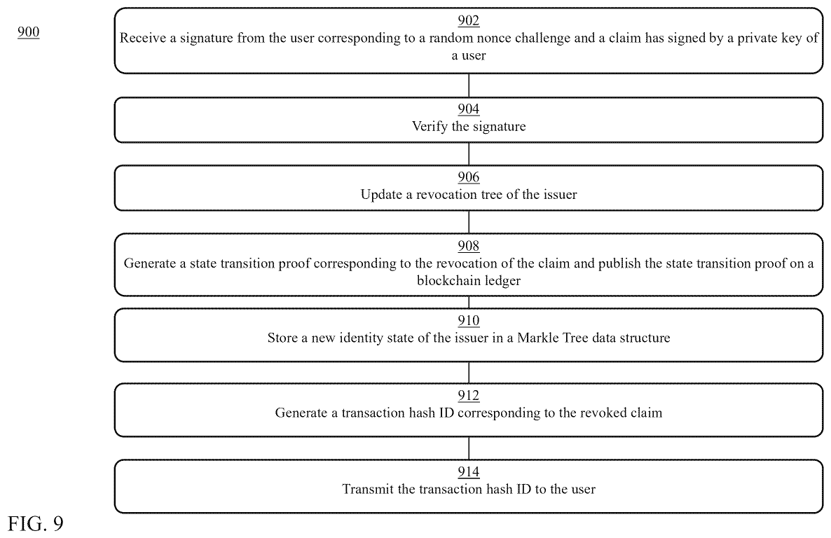

A method 900 for generating a transaction has ID based on the revocation of a claim is described with reference to FIG. 9. At step 902, the issuer receives a signature from the user corresponding to the random nonce challenged and the claimHash signed by the user private key. At step 904, the issuer verifies the received signature in order to authenticate the user. If the verification of the signature is successful (i.e., the signature is valid), the issuer executes step 906 and updates the issuer's revocation tree by adding the revocation nonce corresponding to the claim to be revoked to the revocation tree. This can include the issuer adding a new leaf to the revocation tree with the revocation nonce. At step 908, a state transition proof corresponding to the revocation of the claim is generated and published on a blockchain ledger, e.g., state contract 104, to update a state of the issuer based on the claim revocation. This can include the issuer generating a zero-knowledge proof corresponding to the change of identity state of the issuer from prior to updating the issuer's revocation tree to after the issuer's revocation tree is updated. At step 910, the issuer can store the new identity state of the issuer in a Merkle tree. This can include the issuer adding a leaf to a Merkle tree corresponding to the new identity state of the issuer, which is determined according to state_{new}={state, claimRoot, revocRoot, rootRoot}. In some embodiments the Merkle tree is stored on a reverse hash service, e.g., RHS 106. At step 912, the issuer generates a transaction hash ID, which is a unique identifier representing the revoked claim. At step 914, the issuer transmits the transaction hash ID of the revoked claim to the user.

Returning to FIG. 8, step 810 includes receiving a transaction hash ID corresponding to the revocation of the claim. This can include the issuer receiving the transaction hash ID corresponding to the revocation of the claim transmitted by the issuer in step 914 of method 900. When the user receives the transaction hash ID, the user can check whether the transaction hash ID is finalized by querying the blockchain ledger where the transaction has ID is published, e.g., state contract 104. At step 812, the user updates a revocation tree of user by adding a revoke nonce of the revoked claim to the revocation tree. This can include the user adding a new leaf to a Merkle tree data structure corresponding to the revocation tree, where the new leaf includes the revocation nonce of the revoked claim, indicating that the claim has been revoked. At step 814, the user generates a state transition proof corresponding to the state transition of the user based at least in part on the revocation of the claim and publishes the state transition proof to a blockchain ledger. This can include the user generating a zero-knowledge proof of the transition from the old identity state of the user prior to the claim revocation to the new identity state of the user after claim revocation and publishing the state transition proof on state contract 104 to update the state of the user. At step 816, the user stores the new state of the user as a node on a reverse hash service, e.g., RHS 106. This can include the user adding a new leaf to a Merle tree on RHS 106 corresponding to the revocation tree of the user.

In addition to claim generation and verification, a policy proof can also generated and verified within computing environment 100. As discussed earlier, a policy is a set of one or more claims. In some embodiments, policy proof generation and verification can be performed by a user, e.g., users 101, an issuer, e.g., issuers 102, or a verification server, e.g., verification server 103.

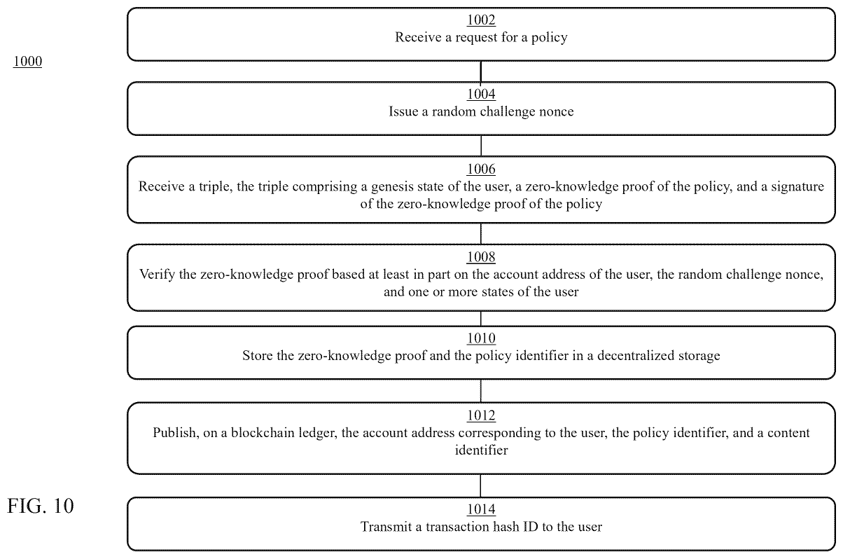

A method 1000 for verifying a policy proof is described with reference to FIG. 10. At step 1002, a request for a policy proof can be received. In some embodiments, a verification server, e.g., verification server 103, receives a request for a policy proof from a user, e.g., users 101. The request can include a policy identifier identifying the policy, a user identifier identifying the user, one or more blockchain identifiers corresponding to the blockchain ledgers on which the user's state will be updated based on the policy proof, which can include state contract 104 and/or verification contract 107, and instructions configured to cause the verification server to generate a proof for the policy. In some embodiments, the user can specify that the account is related to the policy. By specifying the blockchain identifiers corresponding to the blockchain ledgers on which the user's state will be updated, the user's state can be updated appropriately based on verification of the proof on the blockchains corresponding to the blockchain identifiers specified in the request.

At step 1004, a new random challenge nonce is issued to the user. This can include the verification server generating a random challenge nonce and transmitting the random challenge nonce to the user. At step 1006, a triple is received. This can include the verification server receiving the triple from the user. The triple can include a zero-knowledge proof of the policy, a genesis state of the user corresponding to the policy, and a signature of the zero-knowledge proof of the policy. The zero-knowledge proof can be generated based at least in part on the random challenge nonce, the user identifier corresponding to the user, and user data corresponding to the policy. Because a policy is a set of one or more claims, the user data input into the zero-knowledge proof corresponds to the claim values of the one or more claims that make up the policy. The user can generate the zero-knowledge proof, such as but not limited to a zkSNARK proof, according to, for example, step 312 of method 300, using these inputs. Here, the user can also sign the proof using a user private key, e.g., Uₛₖ, which may be derived according to this disclosure. As discussed previously, the genesis state of the user can be determined according to U_{genesis}=ComputeGenesis (U_{add}, Authᵤₚₖ).

At step 1008, the signature of the zero-knowledge proof of the policy is verified. This can include verification server 103 verifying the signature to ensure that the user account corresponding to the user identifier in the request matches the user account associated with the signature such as ECDSA scheme. The verification server can then verify the zero-knowledge proof with a verification key that is publicly available to ensure that the policy is satisfied with the account address of user U, the new random challenge nonce, and one or more states of the user. At step 1010, the zero-knowledge proof of the policy and the policy identifier corresponding to the policy in the zero-knowledge proof is stored. This can include the verification server storing the zero-knowledge proof of the policy received from the user and the policy identifier corresponding to the policy and contained in the user request from step 1002 in a decentralized storage, e.g., decentralized storage 105, which may be an IPFS. In some embodiments, step 1010 further includes the verification server storing the genesis state of the user and the signature of the zero-knowledge proof of the policy contained in the triple received at step 1006 in the decentralized storage. In some embodiments, step 1010 further includes generating a content identifier (CID) corresponding to the zero-knowledge proof of the policy and storing the content identifier with the zero-knowledge proof of the policy received from the user and the policy identifier in the decentralized storage. At step 1012, the user identifier, the policy identifier, and the content identifier are published on a blockchain ledger. This can include the verification server publishing a triple of (account, PolicyID, CID) corresponding to the policy the blockchains matching the one or more blockchain identifiers specified in the request for the policy, which can include but are not limited to, state contract 104 and verifier contract 107. Step 1012 can further include the verification server generating a transaction hash ID corresponding to the verification of the policy. At step 1014, the transaction ID is transmitted to the user. This can include the verification server transmitting the transaction ID to the user.

This process protects the privacy of the user because the user does not have to reveal any sensitive information about the user to the verification server to generate the proof. The proofs are tamper-proof because they are generated using a secure cryptographic process and the verification results are published to the decentralized storage. The process is transparent because the verification results are published to a blockchain contract, which is auditable by the public.

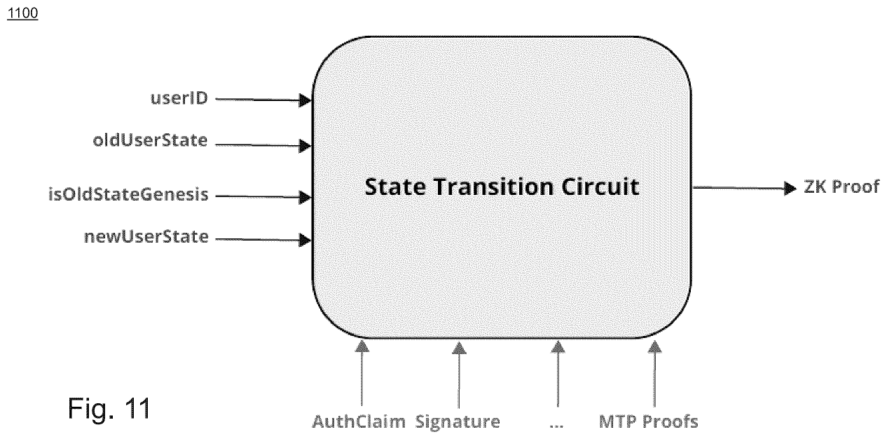

In some embodiments, a state transition circuit may be used to compute the zero-knowledge proof. As illustrated in FIG. 11, a state transition circuit 1100 may receive a user ID, and old user state, a new user state, and an old genesis state of the user, all of which are public information available to any user or entity in computing environment 100 shown in FIG. 1 through one of the blockchain ledgers, e.g., state contract 104 and/or verification server 107, or decentralized storage 105. State transition circuit 1100 may also receive a digital signature, any MTP proofs, and the result of the user's AuthClaim function, all of which are private information not available to the public in computing environment 100. State transition circuit 1100 can then output a zero-knowledge proof.

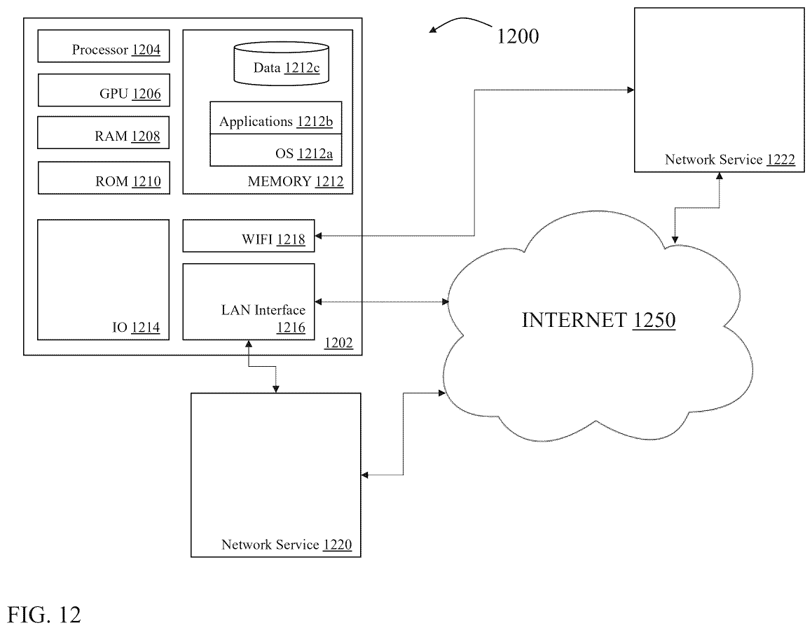

FIG. 12 shows an illustrative block diagram of system 1200 that includes computer 1202. Computer 1202 may alternatively be referred to herein as a “server” or a “computing device.” Computer 1202 may be a workstation, desktop, laptop, tablet, smart phone, or any other suitable computing device. Elements of system 1200, including computer 1202, may be used to implement various aspects of the systems and methods disclosed herein.

Computer 1202 may have a processor 1204 for controlling the operation of the device and its associated components, and may include one or more GPUs 1206, RAM 1208, ROM 1210, input/output module 1214, and a memory 1212. The processor 1204 may also execute all software running on the computer, e.g., the operating system 1212a and/or various applications 1212b, e.g., a digital wallet, a registry service, an information verifier, a network application, a blockchain network node. Other components commonly used for computers, such as EEPROM or flash memory or any other suitable components, may also be part of the computer 1202 as one will appreciate upon reading this disclosure in its entirety. In various embodiments, applications 1212b may include instructions embodied in software for carrying out one or more steps described herein or embodying one or more structures disclosed herein.

The memory 1212 may be comprised of any suitable combination of transitory and non-transitory storage technology as required by design implementation of systems and methods in accordance with this disclosure, and information may be moved between them as needed. The memory 1212 may store software including the operating system 1212a and application(s) 1212b along with any data 1212c needed for the operation of the system 1200. Memory 1212 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 1202 may execute the instructions embodied by the software to perform various functions.

Input/output (“I/O”) module 1214 may include connectivity to a microphone, keyboard, touch screen, mouse, and/or stylus through which a user of computer 1202 may provide input. The input may include input relating to cursor movement. The input may relate to assembling, storing, and leveraging travel data. The input/output module may also include one or more speakers for providing audio output and a video display device for providing textual, audio, audiovisual, and/or graphical output. The input and output may be related to computer application functionality. The input and output may be related to assembling, storing, and leveraging travel data.

System 1200 may be connected to other systems via a local area network (LAN) interface 1216.

System 1200 may operate in a networked environment supporting connections to one or more network services, e.g., remote computers, such as network service 1220 and 1222. Network services 1220 and 1222 may be personal computers or servers that include many or all of the elements described above relative to system 1200. The network connections depicted in FIG. 12 include a local area network (LAN) and wide area networks (WAN), but may also include other networks. When used in a LAN networking environment, computer 1202 is connected to such a LAN through a LAN interface or adapter 1216. When used in a wireless networking environment, computer 1202 may include a wifi network adapter 1218 or other means for establishing communications over wireless. Various communication in embodiments disclosed above further communicate via a WAN such as the internet 1250 as discussed above.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 1212b, which may be used by computer 1202, may include computer executable instructions for invoking user functionality related to communication. Application program(s) 1212b may include computer executable instructions for invoking user functionality related performing various tasks as described herein. The various tasks may be related to assembling, storing, and leveraging identity trait information and related data and encoded data, encrypted or obfuscated, as described herein.

Computer 1202 and/or network resources 1220 and 1222 may also be devices including various other components, such as a battery, speaker, and/or antennas (not shown).

Any information described above, and any other suitable information, may be stored in a memory, e.g., 1208, 1210, or 1212. One or more of applications 1212b may include one or more algorithms that may be used to implement features of the disclosure, and/or any other suitable tasks.

The equipment described in reference to FIG. 12, one will appreciate upon reading this disclosure in its entirety, may be employed to implement various processes, devices, systems, instructions, or methods in accordance with this disclosure.

Embodiments in accordance with this disclosure may be operational with numerous other general purpose or special purpose computing system environments or configurations. Examples of computing systems, environments, and/or configurations that may be suitable for use with embodiments in accordance with this disclosure include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

Embodiments in accordance with this disclosure may be described in the general context of computer-executable instructions, such as program modules, being executed by a computer. Generally, program modules include routines, programs, objects, components, data structures, etc., that perform particular tasks or implement particular data types. Embodiments in accordance with this disclosure may also be practiced in distributed computing environments where tasks are performed by remote processing devices that are linked through a communications network. In a distributed computing environment, program modules can be located in both local and remote computer storage media including memory storage devices.

The system, apparatus, module, or units illustrated in the previous implementations can be implemented by using a computer chip, or can be implemented by using a product having a certain function by virtue of its configuration or instructions. A typical implementation device, e.g., for implementing a digital wallet and the functions attributed thereto herein, is a computer, and the computer can be a personal computer, a laptop computer, a cellular phone, a camera phone, a smartphone, a personal digital assistant, an email receiving and sending device, a game console, a tablet computer, a wearable device, or any combination of these devices. A typical implementation device, e.g., for implementing the network applications and blockchain processing herein, is a computer, and the computer can be a personal computer, a server, a server operatively coupled with one or more GPUs, or a laptop computer. A cellular phone, a camera phone, a smartphone, a personal digital assistant, an email receiving and sending device, a game console, a tablet computer, a wearable device, or any combination of these devices may perform these features as well.

In an exemplary embodiment, a computer includes one or more processors (CPU), an input/output interface, a network interface, and a memory. A computer may include one or more GPUs or special processing devices for performing blockchain processing.

The memory may include a non-persistent memory, a random access memory (RAM), a non-volatile memory, and/or another form in a computer readable medium, for example, a read-only memory (ROM) or a flash memory (flash RAM). The memory is an example of, without limitation, the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on grapheme, another magnetic storage device, or any other non-transmission medium. The computer storage medium can be used to store information that can be accessed by the computing device.

It is worthwhile to further note that, the terms “include”, “contain”, or their any other variants are intended to cover a non-exclusive inclusion, so a process, a method, a product or a device that includes a list of elements not only includes those elements but may also includes other elements which are not expressly listed, or further includes elements inherent to such process, method, product or device. Without more constraints, an element preceded by “includes a . . . ” does not preclude the existence of additional identical elements in the process, method, product or device that includes the element.

Various implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or can be advantageous.

Terms used in one or more implementations of the present specification are merely used to describe specific implementations, and are not intended to limit the one or more implementations of the present specification. The terms “a” and “the” of singular forms used in one or more implementations of the present specification and the appended claims are also intended to include plural forms, unless otherwise specified in the context clearly. It should also be understood that, the term “and/or” used here indicates and includes any or all possible combinations of one or more associated listed items. Unless explicitly stated herein to the contrary, the terms for example or e.g., mean: for example without limitation. Unless explicitly stated herein to the contrary, the terms in embodiments, in various embodiments, and in some embodiments mean: in one or more but not necessarily all embodiments.

It should be understood that although terms “first”, “second”, “third”, etc. can be used in one or more implementations of the present specification to describe various types of information, the information is not limited to these terms. These terms are only used to differentiate between information of the same type. For example, without departing from the scope of one or more implementations of the present specification, first information can also be referred to as second information, and similarly, the second information can be referred to as the first information. Depending on the context, for example, the word “if” used here can be explained as “while”, “when”, or “in response to determining”.

The previous descriptions are only example implementations of one or more implementations of the present specification, but are not intended to limit the one or more implementations of the present specification. Any modification, equivalent replacement, improvement, etc. made without departing from the spirit and principle of the one or more implementations of the present specification shall fall within the protection scope of the one or more implementations of the present specification.

What is claimed:

1. A computer implemented method for verifying a policy proof, the method comprising:
receiving, by at least one processor of one or more processors that are communicably coupled to a computing environment, a request from a user for a policy,
wherein the request comprises a policy identifier corresponding to the policy, and
wherein the policy comprises one or more queries, each query is based at least in part on a claim, and each claim comprises a claim index and a claim value;
issuing, by at least one processor of one or more processors that are communicably coupled to the computing environment, a first random challenge nonce;
receiving, by at least one processor of one or more processors that are communicably coupled to the computing environment, a first triple comprising:
a first genesis state of the user;
a zero-knowledge proof of the policy based at least in part on the first random challenge nonce, an account address corresponding to the user, and user data; and
a signature of the zero-knowledge proof of the policy;
verifying, by at least one processor of one or more processors that are communicably coupled to the computing environment, the zero-knowledge proof of the policy based at least in part on the account address of the user, the first random challenge nonce, and one or more states of the user;
storing, by at least one processor of one or more processors that are communicably coupled to the computing environment, the zero-knowledge proof and the policy identifier in a decentralized storage; and
publishing, by at least one processor of one or more processors that are communicably coupled to the computing environment, the account address corresponding to the user, the policy identifier, and a content identifier to one or more blockchain ledgers, wherein the content identifier corresponds to the claims of the one or more queries of the policy.

2. The method of claim 1, further comprising:
generating, by at least one processor of one or more processors that are communicably coupled to a computing environment, a transaction hash ID corresponding to a verification of the policy; and
transmitting, by at least one processor of one or more processors that are communicably coupled to the computing environment, the transaction has ID to the user.

3. The method of claim 1, further comprising:
revoking, by at least one processor of one or more processors that are communicably coupled to the computing environment, at least one of the one or more claims of the policy, wherein revoking at least one of the one or more claims of the policy comprises:
receiving, by at least one processor of one or more processors that are communicably coupled to the computing environment, a request to revoke at least one of the one or more claims of the policy, the request comprising the account address of the user and a claim index corresponding to at least one of the one or more claims of the policy to be revoked;
transmitting, by at least one processor of one or more processors that are communicably coupled to the computing environment, a second triple to an issuer, the second triple comprising:
a second genesis state of the user;
a signature of a second random challenge nonce and a hash of the claim value corresponding to the claim index of the claim, wherein the at least one of the one or more claims of the policy to be revoked; and
a revocation nonce of the at least one of the one or more claims of the policy to be revoked;
receiving, by at least one processor of one or more processors that are communicably coupled to the computing environment, a transaction hash ID corresponding to the revocation of the at least one of the one or more claims of the policy to be revoked;
updating, by at least one processor of one or more processors that are communicably coupled to the computing environment, a revocation tree based at least in part on the revocation of the at least one of the one or more claims of the policy to be revoked;
generating, by at least one processor of one or more processors that are communicably coupled to the computing environment, a state transition proof of the user based at least in part on the revocation of the at least one of the one or more claims of the policy to be revoked; and
publishing, by at least one processor of one or more processors that are communicably coupled to the computing environment, the state transition proof to one or more blockchain ledgers.

4. The method of claim 1, wherein the zero-knowledge proof of the policy is a SNARK proof.

5. The method of claim 1, further comprising:
registering, by at least one processor of one or more processors that are communicably coupled to the computing environment, the user with an issuer, wherein registering the user with an issuer comprises:
requesting, by at least one processor of one or more processors that are communicably coupled to the computing environment, registration with an issuer;
signing, by at least one processor of one or more processors that are communicably coupled to the computing environment, a third random challenge nonce with a private key of the user;
receiving, by at least one processor of one or more processors that are communicably coupled to the computing environment, an access token based at least in part on a verification of the signed third random challenge nonce;
transmitting, by at least one processor of one or more processors that are communicably coupled to the computing environment, a third triple comprising:
a blockchain address corresponding to a user encryption key pair;
a user encryption key; and
a user public authentication key; and
receiving, by at least one processor of one or more processors that are communicably coupled to the computing environment, a success flag, the success flag based at least in part on a third genesis state of the user, the third genesis state of the user being determined based at least in part on the user public authentication key and the blockchain address corresponding to the user encryption key pair.

6. The method of claim 5, wherein the user public encryption key is derived from a Baby Jubjub curve.

7. The method of claim 1, further comprising:
updating, by at least one processor of one or more processors that are communicably coupled to the computing environment, at least one of the one or more claims of the policy.

8. A system for verifying a policy proof, the system comprising:
one or more processors; and
one or more memories operatively coupled to at least one of the one or more processors and comprising instructions stored thereon that, when executed by at least one of the one or more processors, cause at least one of the one or more processors to:
receive a request from a user for a policy,
wherein the request comprises a policy identifier corresponding to the policy, and
wherein the policy comprises one or more queries, each query is based at least in part on a claim, and each claim comprises a claim index and a claim value;
issue a first random challenge nonce;
receive a first triple comprising:
a first genesis state of the user;
a zero-knowledge proof of the policy based at least in part on the first random challenge nonce, an account address corresponding to the user, and user data; and
a signature of the zero-knowledge proof of the policy;
verify the zero-knowledge proof of the policy based at least in part on the account address of the user, the first random challenge nonce, and one or more states of the user;
store the zero-knowledge proof and the policy identifier in a decentralized storage; and
publish the account address corresponding to the user, the policy identifier, and a content identifier to one or more blockchain ledgers, wherein the content identifier corresponds to the claims of the one or more queries of the policy.

9. The system of claim 8, wherein at least one of the one or more memories comprises further instructions stored thereon that, when executed by at least one of the one or more processors, cause at least one of the one or more processors to:
generate a transaction hash ID corresponding to a verification of the policy; and
transmit the transaction has ID to the user.

10. The system of claim 8, wherein at least one of the one or more memories comprises further instructions stored thereon that, when executed by at least one of the one or more processors, cause at least one of the one or more processors to:
revoke at least one of the one or more claims of the policy, wherein the instructions that cause at least one of the one or more processors to revoke at least one of the one or more claims of the policy cause at least one of the one or more processors to:
receive a request to revoke at least one of the one or more claims of the policy, the request comprising the account address of the user and a claim index corresponding to at least one of the one or more claims of the policy to be revoked;
transmit a second triple to an issuer, the second triple comprising:
a second genesis state of the user;
a signature of a second random challenge nonce and a hash of the claim value corresponding to the claim index of the claim, wherein the at least one of the one or more claims of the policy to be revoked; and
a revocation nonce of the at least one of the one or more claims of the policy to be revoked;
receive a transaction hash ID corresponding to the revocation of the at least one of the one or more claims of the policy to be revoked;
update a revocation tree based at least in part on the revocation of the at least one of the one or more claims of the policy to be revoked;
generate a state transition proof of the user based at least in part on the revocation of the at least one of the one or more claims of the policy to be revoked; and
publish the state transition proof to one or more blockchain ledgers.

11. The system of claim 8, wherein the zero-knowledge proof of the policy is a SNARK proof.

12. The system of claim 8, wherein at least one of the one or more memories has further instructions stored thereon that, when executed by at least one of the one or more processors, cause at least one of the one or more processors to:
register the user with an issuer, wherein the instructions that cause at least one of the one or more processors to register the user with an issuer further cause at least one of the one or more processors to:
requesting, by at least one processor of one or more processors that are communicably coupled to the computing environment, registration with an issuer;
sign a third random challenge nonce with a private key of the user;
receive an access token based at least in part on a verification of the signed third random challenge nonce;
transmit a third triple comprising:
a blockchain address corresponding to a user encryption key pair;
a user encryption key; and
a user public authentication key; and
receive a success flag, the success flag based at least in part on a third genesis state of the user, the third genesis state of the user being determined based at least in part on the user public authentication key and the blockchain address corresponding to the user encryption key pair.

13. The system of claim 12, wherein the user public encryption key is derived from a Baby Jubjub curve.

14. The system of claim 8, wherein at least one of the one or more memories has further instructions stored thereon that, when executed by at least one of the one or more processors, cause at least one of the one or more processors to:
update at least one of the one or more claims of the policy.

15. At least one non-transitory computer-readable medium storing computer-readable instructions for verifying a policy proof that, when executed by one or more computing devices of an application client, cause at least one of the one or more computing devices to:
receive a request from a user for a policy,
wherein the request comprises a policy identifier corresponding to the policy, and
wherein the policy comprises one or more queries, each query is based at least in part on a claim, and each claim comprises a claim index and a claim value;
issue a first random challenge nonce;
receive a first triple comprising:
a first genesis state of the user;
a zero-knowledge proof of the policy based at least in part on the first random challenge nonce, an account address corresponding to the user, and user data; and
a signature of the zero-knowledge proof of the policy;
verify the zero-knowledge proof of the policy based at least in part on the account address of the user, the first random challenge nonce, and one or more states of the user;
store the zero-knowledge proof and the policy identifier in a decentralized storage; and
publish the account address corresponding to the user, the policy identifier, and a content identifier to one or more blockchain ledgers, wherein the content identifier corresponds to the claims of the one or more queries of the policy.

16. The at least one non-transitory computer-readable medium of claim 15, further storing computer-readable instructions that, when executed by at least one of the one or more computing devices, cause at least one of the one or more computing devices to:
generate a transaction hash ID corresponding to a verification of the policy; and
transmit the transaction has ID to the user.

17. The at least one non-transitory computer-readable medium of claim 15, further storing computer-readable instructions that, when executed by at least one of the one or more computing devices, cause at least one of the one or more computing devices to:
revoke at least one of the one or more claims of the policy, wherein the instructions that cause at least one of the one or more processors to revoke at least one of the one or more claims of the policy cause at least one of the one or more processors to:
receive a request to revoke at least one of the one or more claims of the policy, the request comprising the account address of the user and a claim index corresponding to at least one of the one or more claims of the policy to be revoked;
transmit a second triple to an issuer, the second triple comprising:
a second genesis state of the user;
a signature of a second random challenge nonce and a hash of the claim value corresponding to the claim index of the claim, wherein the at least one of the one or more claims of the policy to be revoked; and
a revocation nonce of the at least one of the one or more claims of the policy to be revoked;
receive a transaction hash ID corresponding to the revocation of the at least one of the one or more claims of the policy to be revoked;
update a revocation tree based at least in part on the revocation of the at least one of the one or more claims of the policy to be revoked;
generate a state transition proof of the user based at least in part on the revocation of the at least one of the one or more claims of the policy to be revoked; and
publish the state transition proof to one or more blockchain ledgers.

18. The at least one non-transitory computer-readable medium of claim 15, further storing computer-readable instructions that, when executed by at least one of the one or more computing devices, cause at least one of the one or more computing devices to:
register the user with an issuer, wherein the instructions that cause at least one of the one or more processors to register the user with an issuer further cause at least one of the one or more processors to:
requesting, by at least one processor of one or more processors that are communicably coupled to the computing environment, registration with an issuer;
sign a third random challenge nonce with a private key of the user;
receive an access token based at least in part on a verification of the signed third random challenge nonce;
transmit a third triple comprising:
a blockchain address corresponding to a user encryption key pair;
a user encryption key; and
a user public authentication key; and
receive a success flag, the success flag based at least in part on a third genesis state of the user, the third genesis state of the user being determined based at least in part on the user public authentication key and the blockchain address corresponding to the user encryption key pair.

19. The at least one non-transitory computer-readable medium of claim 18, wherein the user public encryption key is derived from a Baby Jubjub curve.

20. The at least one non-transitory computer-readable medium of claim 15, further storing computer-readable instructions that, when executed by at least one of the one or more computing devices, cause at least one of the one or more computing devices to:
update at least one of the one or more claims of the policy.
